(19) United States
(12) Patent Application Publication
(10) Pub. No.: US 2011/0251358 A1
(43) Pub. Date: Oct. 13, 2011

(54) OLIGOMERIZATION OF BIS(BETA-HYDROXY) POLYSULFIDES THROUGH ETHERIFICATION

(75) Inventors: Jim D. Byers, Bartlesville, OK (US); Michael S. Matson, Bartlesville, OK (US); Mitchell D. Refvik, Bartlesville, OK (US)

(73) Assignee: Chevron Phillips Chemical Company LP, The Woodlands, TX (US)

(21) Appl. No.: 13/083,942

(22) Filed: Apr. 11, 2011

Related U.S. Application Data
(60) Provisional application No. 61/323,094, filed on Apr. 12, 2010.

(51) Int. Cl. C08L 81/04; C08G 75/14

(52) U.S. Cl. 525/535; 528/373

(57) ABSTRACT

The present invention discloses compositions comprising oligomers derived from bis(beta-hydroxy)polysulfides, such as dihydroxydiethyl disulfide, and oligomerization processes for producing these compositions.

### REFERENCE TO RELATED APPLICATION

This application claims the benefit of U.S. Provisional Application Ser. No. 61/323,094, filed on Apr. 12, 2010, the disclosure of which is incorporated herein by reference in its entirety.

### BACKGROUND OF THE INVENTION

The present invention relates generally to compositions comprising oligomers derived from bis(beta-hydroxy)polysulfides, and processes for the oligomerization of such bis(beta-hydroxy)polysulfides.

Oligomers derived from bis(beta-hydroxy)polysulfides can be used as hardeners in coating formulations and compositions.

### SUMMARY OF THE INVENTION

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Processes for oligomerizing one or more bis(beta-hydroxy)polysulfides in the presence of acid catalyst are disclosed herein. In accordance with embodiments of the present invention, one such process may comprise:

a) contacting an acid catalyst and a composition comprising (or consisting essentially of, or consisting of) a bis(beta-hydroxy)polysulfide; and

b) oligomerizing the bis(beta-hydroxy)polysulfide to form oligomers comprising units derived from the bis(beta-hydroxy)polysulfide.

In some embodiments, the contacting step and/or the oligomerizing step may be conducted in the substantial absence of an organic solvent. Additionally, or alternatively, the contacting step and/or the oligomerizing step may be performed at a pressure of less than 100 Torr and/or at a temperature in a range from 100° C. to 180° C.

Embodiments of this invention also are directed to oligomer compositions comprising oligomers produced by the disclosed processes.

Further, compositions comprising oligomers derived from an acid-catalyzed oligomerization of bis(beta-hydroxy)polysulfides, as well as compositions comprising oligomers wherein the oligomers comprise units derived from a bis(beta-hydroxy)polysulfide, are disclosed in other embodiments of this invention. In some embodiments, the cyclic oligomer content of the composition increases as the average molecular weight of the composition increases.

Both the foregoing summary and the following detailed description provide examples and are explanatory only. Accordingly, the foregoing summary and the following detailed description should not be considered to be restrictive. Further, features or variations may be provided in addition to those set forth herein. For example, certain embodiments may be directed to various feature combinations and sub-combinations described in the detailed description.

### BRIEF DESCRIPTION OF THE FIGURES

FIG. 1 presents a plot of the percentage of cyclic compounds in the oligomerized product compositions of Examples 1-3, 9-11, 15, and 18, as a function of the weight-average molecular weight (M_{w}) of the respective composition.

FIG. 2 presents another plot of the percentage of cyclic compounds in the oligomerized product compositions of Examples 1-3, 9-11, 15, and 18, as a function of the weight-average molecular weight (M_{w}) of the respective composition.

FIG. 3 presents a plot of the percentage of cyclic compounds in the oligomerized product compositions of Examples 1-3, 9-11, 15, and 18, as a function of the weight-average molecular weight (M_{w}) of the oligomers of the respective composition.

FIG. 4 presents another plot of the percentage of cyclic compounds in the oligomerized product compositions of Examples 1-3, 9-11, 15, and 18, as a function of the weight-average molecular weight (M_{w}) of the oligomers of the respective composition.

FIG. 5 presents an HPLC plot from a preparative HPLC method analysis of the oligomerized product composition of Example 1.

FIG. 6 presents a H-1 NMR plot of the oligomerized product composition of Example 1.

FIG. 7 presents a C-13 NMR plot of the oligomerized product composition of Example 1.

FIG. 8 presents a GPC plot of the molecular weight distribution of the oligomerized product composition of Example 1.

FIG. 9 presents a H-1 NMR plot of the oligomerized product composition of Example 2.

FIG. 10 presents a C-13 NMR plot of the oligomerized product composition of Example 2.

FIG. 11 presents a GPC plot of the molecular weight distribution of the oligomerized product composition of Example 2.

FIG. 12 presents a H-1 NMR plot of the oligomerized product composition of Example 4.

FIG. 13 presents a C-13 NMR plot of the oligomerized product composition of Example 4.

FIG. 14 presents a H-1 NMR plot of the oligomerized product composition of Example 5.

FIG. 15 presents a C-13 NMR plot of the oligomerized product composition of Example 5.

FIG. 16 presents an HPLC plot from a preparative HPLC method analysis of the oligomerized product composition of Example 6.

FIG. 17 presents a H-1 NMR plot of the oligomerized product composition of Example 6.

FIG. 18 presents a C-13 NMR plot of the oligomerized product composition of Example 6.

FIG. 19 presents a GPC plot of the molecular weight distribution of the oligomerized product composition of Example 6.

FIG. 20 presents an HPLC plot from an analytical HPLC method analysis of the oligomerized product composition of Example 2.

FIG. 21 presents an HPLC plot from an analytical HPLC method analysis of the oligomerized product composition of Example 9.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Regarding claim transitional terms or phrases, the transitional term “comprising,” which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Absent an indication to the contrary, describing a compound or composition as “consisting essentially of” is not to be construed as “comprising,” but is intended to describe the recited component that includes materials which do not significantly alter the composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of apply only to the feature class to which it is utilized, and it is possible to have different transitional terms or phrases utilized with different features within a claim. For example, a method can comprise several recited steps (and other non-recited steps), but utilize a catalyst system preparation consisting of specific components; alternatively, consisting essentially of specific components; or alternatively, comprising the specific components and other non-recited components.

While compositions and methods are described in terms of “comprising” various components or steps, the compositions and methods can also “consist essentially of” or “consist of” the various components or steps.

The terms “a,” “an,” and “the” are intended to include plural alternatives, e.g., at least one. For instance, the disclosure of “a bis(beta-hydroxy)polysulfide,” “an acid catalyst,” etc., is meant to encompass one, or mixtures or combinations of more than one, bis(beta-hydroxy)polysulfide, acid catalyst, etc., unless otherwise specified.

For any particular compound or group disclosed herein, any name or structure presented is intended to encompass all conformational isomers, regioisomers, and stereoisomers that may arise from a particular set of substituents, unless otherwise specified. For example, a general reference to pentane includes n-pentane, 2-methyl-butane, and 2,2-dimethylpropane, and a general reference to a butyl group includes an n-butyl group, a sec-butyl group, an iso-butyl group, and a t-butyl group. The name or structure also encompasses all enantiomers, diastereomers, and other optical isomers whether in enantiomeric or racemic forms, as well as mixtures of stereoisomers, as would be recognized by a skilled artisan, unless otherwise specified.

In one aspect, a chemical “group” can be defined or described according to how that group is formally derived from a reference or “parent” compound, for example, by the number of hydrogen atoms removed from the parent compound to generate the group, even if that group is not literally synthesized in such a manner. These groups can be utilized as substituents or coordinated or bonded to metal atoms. By way of example, an “alkyl group” formally can be derived by removing one hydrogen atom from an alkane, while an “alkylene group” formally can be derived by removing two hydrogen atoms from an alkane. Moreover, a more general term can be used to encompass a variety of groups that formally are derived by removing any number (“one or more”) hydrogen atoms from a parent compound, which in this example can be described as an “alkane group,” and which encompasses an “alkyl group,” an “alkylene group,” and materials having three or more hydrogen atoms, as necessary for the situation, removed from an alkane. The disclosure that a substituent, ligand, or other chemical moiety may constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedures, unless specified otherwise or the context requires otherwise.

The term “organyl group” is used herein in accordance with the definition specified by IUPAC: an organic substituent group, regardless of functional type, having one free valence at a carbon atom. Similarly, an “organylene group” refers to an organic group, regardless of functional type, derived by removing two hydrogen atoms from an organic compound, either two hydrogen atoms from one carbon atom or one hydrogen atom from each of two different carbon atoms. An “organic group” refers to a generalized group formed by removing one or more hydrogen atoms from carbon atoms of an organic compound. Thus, an “organyl group,” an “organylene group,” and an “organic group” can contain organic functional group(s) and/or atom(s) other than carbon and hydrogen, that is, an organic group that can comprise functional groups and/or atoms in addition to carbon and hydrogen. For instance, non-limiting examples of atoms other than carbon and hydrogen include halogens, oxygen, nitrogen, phosphorus, and the like. Non-limiting examples of functional groups include ethers, aldehydes, ketones, esters, sulfides, amines, and phosphines, and so forth. An “organyl group,” “organylene group,” or “organic group” may be aliphatic, inclusive of being cyclic or acyclic, or may be aromatic. “Organyl groups,” “organylene groups,” and “organic groups” also encompass heteroatom-containing rings, heteroatom-containing ring systems, heteroaromatic rings, and heteroaromatic ring systems. “Organyl groups,” “organylene groups,” and “organic groups” may be linear or branched unless otherwise specified. Finally, it is noted that the “organyl group,” “organylene group,” and “organic group” definitions include “hydrocarbyl group,” “hydrocarbylene group,” and “hydrocarbon group,” respectively, and “alkyl group,” “alkylene group,” and “alkane group,” respectively, as members.

The term “hydrocarbyl group” is used herein in accordance with the definition specified by IUPAC: a univalent group formed by removing a hydrogen atom from a hydrocarbon (that is, a group containing only carbon and hydrogen). Non-limiting examples of hydrocarbyl groups include ethyl, phenyl, tolyl, propenyl, and the like. Similarly, a “hydrocarbylene group” refers to a group formed by removing two hydrogen atoms from a hydrocarbon, either two hydrogen atoms from one carbon atom or one hydrogen atom from each of two different carbon atoms. Therefore, in accordance with the terminology used herein, a “hydrocarbon group” refers to a generalized group formed by removing one or more hydrogen atoms (as necessary for the particular group) from a hydrocarbon. A “hydrocarbyl group,” “hydrocarbylene group,” and “hydrocarbon group” can be acyclic or cyclic groups, and/or may be linear or branched. A “hydrocarbyl group,” “hydrocarbylene group,” and “hydrocarbon group” can include rings, ring systems, aromatic rings, and aromatic ring systems, which contain only carbon and hydrogen. “Hydrocarbyl groups,” “hydrocarbylene groups,” and “hydrocarbon groups” include, by way of example, aryl, arylene, arene groups, alkyl, alkylene, alkane groups, cycloalkyl, cycloalkylene, cycloalkane groups, aralkyl, aralkylene, and aralkane groups, respectively, amongst other groups as members.

An aliphatic compound is an acyclic or cyclic, saturated or unsaturated compound, excluding aromatic compounds. That is, an aliphatic compound is a non-aromatic organic compound. An “aliphatic group” is a generalized group formed by removing one or more hydrogen atoms (as necessary for the particular group) from a carbon atom of an aliphatic compound. Aliphatic compounds, and therefore aliphatic groups, may contain organic functional group(s) and/or atom(s) other than carbon and hydrogen.

The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic groups, and/or may be linear or branched unless otherwise specified. Primary, secondary, or tertiary alkyl groups are derived by removal of a hydrogen atom from a primary, secondary, or tertiary carbon atom, respectively, of an alkane. The n-alkyl group is derived by removal of a hydrogen atom from a terminal carbon atom of a linear alkane. The groups RCH₂ (R≠H), R₂CH(R≠H), and R₃C(R≠H) are primary, secondary, and tertiary alkyl groups, respectively.

A cycloalkane is a saturated cyclic hydrocarbon, with or without side chains, for example, cyclobutane or methyl cyclobutane. Unsaturated cyclic hydrocarbons having one or more endocyclic double or one triple bond are called cycloalkenes and cycloalkynes, respectively. Cycloalkenes and cycloalkynes having only one, only two, only three, etc., endocyclic double or triple bonds, respectively, can be identified by use of the term “mono,” “di,” “tri,” etc., within the name of the cycloalkene or cycloalkyne. Cycloalkenes and cycloalkynes can further identify the position of the endocyclic double or triple bonds. Other identifiers can be utilized to indicate the presence of particular groups in the cycloalkane (e.g., halogenated cycloalkane indicates that the presence of one or more halogen atoms replacing an equivalent number of hydrogen atoms in the cycloalkane).

A “cycloalkyl group” is a univalent group derived by removing a hydrogen atom from a ring carbon atom from a cycloalkane. For example, a 1-methylcyclopropyl group and a 2-methylcyclopropyl group are illustrated as follows:

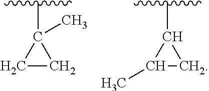

Similarly, a “cycloalkylene group” refers to a group derived by removing two hydrogen atoms from a cycloalkane, at least one of which is a ring carbon. Thus, a “cycloalkylene group” includes both a group derived from a cycloalkane in which two hydrogen atoms are formally removed from the same ring carbon, a group derived from a cycloalkane in which two hydrogen atoms are formally removed from two different ring carbons, and a group derived from a cycloalkane in which a first hydrogen atom is formally removed from a ring carbon and a second hydrogen atom is formally removed from a carbon atom that is not a ring carbon. A “cycloalkane group” refers to a generalized group formed by removing one or more hydrogen atoms (as necessary for the particular group and at least one of which is a ring carbon) from a cycloalkane. It should be noted that according to the definitions provided herein, general cycloalkane groups (including cycloalkyl groups and cycloalkylene groups) include those having zero, one, or more than one hydrocarbyl substituent groups attached to a cycloalkane ring carbon atom (e.g., a methylcyclopropyl group) and are members of the group of hydrocarbon groups. However, when referring to a cycloalkane group having a specified number of cycloalkane ring carbon atoms (e.g., a cyclopentane group or cyclohexane group, among others), the base name of the cycloalkane group having a defined number of cycloalkane ring carbon atoms refers to the unsubstituted cycloalkane group (including having no hydrocarbyl groups located on cycloalkane group ring carbon atom). Consequently, a substituted cycloalkane group having a specified number of ring carbon atoms (e.g., a substituted cyclopentane or substituted cyclohexane, among others) refers to the respective group having one or more substituent groups (including halogens, hydrocarbyl groups, or hydrocarboxy groups, among other substituent groups) attached to a cycloalkane group ring carbon atom. When the substituted cycloalkane group having a defined number of cycloalkane ring carbon atoms is a member of the group of hydrocarbon groups (or a member of the general group of cycloalkane groups), each substituent of the substituted cycloalkane group having a defined number of cycloalkane ring carbon atoms is limited to hydrocarbyl substituent group. One having skill in the art can readily discern and select general groups, specific groups, and/or individual substituted cycloalkane group(s) having a specific number of ring carbons atoms which can be utilized as a member of the hydrocarbon group (or a member of the general group of cycloalkane groups).

An arene is an aromatic hydrocarbon, with or without side chains (e.g., benzene, toluene, or xylene, among others). An “aryl group” is a group derived from the formal removal of a hydrogen atom from an aromatic ring carbon of an arene. It should be noted that the arene can contain a single aromatic hydrocarbon ring (e.g., benzene, or toluene), contain fused aromatic rings (e.g., naphthalene or anthracene), and contain one or more isolated aromatic rings covalently linked via a bond (e.g., biphenyl) or non-aromatic hydrocarbon group(s) (e.g., diphenylmethane). One example of an “aryl group” is ortho-tolyl (o-tolyl), the structure of which is shown here:

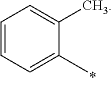

Similarly, an “arylene group” refers to a group formed by removing two hydrogen atoms (at least one of which is from an aromatic ring carbon) from an arene. An “arene group” refers to a generalized group formed by removing one or more hydrogen atoms (as necessary for the particular group and at least one of which is an aromatic ring carbon) from an arene. However, if a group contains separate and distinct arene and heteroarene rings or ring systems (e.g., the phenyl and benzofuran moieties in 7-phenylbenzofuran), its classification depends upon the particular ring or ring system from which the hydrogen atom was removed, that is, an arene group if the removed hydrogen came from the aromatic hydrocarbon ring or ring system carbon atom (e.g., the 2-carbon atom in the phenyl group of 6-phenylbenzofuran), and a heteroarene group if the removed hydrogen carbon came from a heteroaromatic ring or ring system carbon atom (e.g., the 2- or 7-carbon atom of the benzofuran group or 6-phenylbenzofuran). It should be noted that according the definitions provided herein, general arene groups (including an aryl group and an arylene group) include those having zero, one, or more than one hydrocarbyl substituent groups located on an aromatic hydrocarbon ring or ring system carbon atom (e.g., a toluene group or a xylene group, among others) and is a member of the group of hydrocarbon groups. However, a phenyl group (or phenylene group) and/or a naphthyl group (or naphthylene group) refer to the specific unsubstituted arene groups (including no hydrocarbyl group located on an aromatic hydrocarbon ring or ring system carbon atom). Consequently, a substituted phenyl group or substituted naphthyl group refers to the respective arene group having one or more substituent groups (including halogens, hydrocarbyl groups, or hydrocarboxy groups, among others) located on an aromatic hydrocarbon ring or ring system carbon atom. When the substituted phenyl group and/or substituted naphtyl group is a member of the group of hydrocarbon groups (or a member of the general group of arene groups), each substituent is limited to a hydrocarbyl substituent group. One having ordinary skill in the art can readily discern and select general phenyl and/or naphthyl groups, specific phenyl and/or naphthyl groups, and/or individual substituted phenyl or substituted naphthyl groups which can be utilized as a member of the group of hydrocarbon groups (or a member of the general group of arene groups).

An “aralkyl group” is an aryl-substituted alkyl group having a free valance at a non-aromatic carbon atom (e.g., a benzyl group, or a 2-phenyleth-lyl group, among others). Similarly, an “aralkylene group” is an aryl-substituted alkylene group having two free valencies at a single non-aromatic carbon atom or a free valence at two non-aromatic carbon atoms, while an “aralkane group” is a generalized aryl-substituted alkane group having one or more free valencies at a non-aromatic carbon atom(s). It should be noted that according the definitions provided herein, general aralkane groups include those having zero, one, or more than one hydrocarbyl substituent groups located on an aralkane aromatic hydrocarbon ring or ring system carbon atom and is a member of the group of hydrocarbon groups. However, specific aralkane groups specifying a particular aryl group (e.g., the phenyl group in a benzyl group or a 2-phenylethyl group, among others) refer to the specific unsubstituted aralkane groups (including no hydrocarbyl group located on the aralkane aromatic hydrocarbon ring or ring system carbon atom). Consequently, a substituted aralkane group specifying a particular aryl group refers to a respective aralkane group having one or more substituent groups (including halogens, hydrocarbyl groups, or hydrocarboxy groups, among others). When the substituted aralkane group specifying a particular aryl group is a member of the group of hydrocarbon groups (or a member of the general group of aralkane groups), each substituent is limited to a hydrocarbyl substituent group. One having skill in the art can readily discern and select substituted aralkane groups specifying a particular aryl group which can be utilized as a member of the group of hydrocarbon groups (or a member of the general group of aralkane groups).

As used herein, a “polysulfide” refers to a compound having a S_{X} unit, where x is greater than or equal to 2. For instance, compounds having structures such as R^{A}—S—S—R^{B} and R^{A}—S—S—S—R^{B}, with R^{A} and R^{B} being the same or different would be considered a polysulfide in accordance with this invention; a disulfide and a trisulfide, respectively. For illustrative purposes, compounds having structures such as R^{A}—S—R^{B} and R^{A}—S—R^{C}—S—R^{B}, with R^{A}, R^{B}, and R^{C} being the same or different, would not be considered a polysulfide in accordance with this invention. Generally, the polysulfides within a composition comprising, consisting essentially of, or that consists of, polysulfides will contain sulfides having different values of x. Consequently, the polysulfides within a compositions comprising, consisting essentially of, or that consists of, polysulfides may have a non-integer average value for x.

Since there is not an industry-accepted cutoff for the number of repeat units which constitute an “oligomer” as opposed to a “polymer,” Applicants have used the term “oligomer” to refer to compounds which incorporate from 2 to 60 units derived from the monomer utilized to form the oligomer.

Generally, it is difficult to separate the oligomers derived from bis(beta-hydroxy) polysulfides from the monomer bis(beta-hydroxy)polysulfide from which they were derived. Consequently, within this disclosure, properties associated with compositions comprising, or consisting essentially of, oligomers derived from a bis(beta-hydroxy)polysulfide may include contributions from the oligomers and the monomers from which the oligomers were formed. In some circumstances, it may be beneficial to refer only to oligomers derived from the bis(beta-hydroxy)polysulfide, as if the bis(beta-hydroxy)polysulfide monomer had been removed from the composition Within this specification, terms such as “composition oligomers” or “oligomers of the composition” are used when referring to only the oligomers within the composition, in the absence of the contribution of the monomer(s) from which the oligomers were derived. In sum, a “composition” (or an “oligomer composition”) can include monomeric bis(beta-hydroxy)polysulfide compounds, while “oligomers of the composition” cannot. For example, as would be recognized by one of skill in the art, the Mn and/or M_{w} of the composition (residual monomer is included) may be different from the Mn and/or M_{w} of the oligomers of the composition (where residual monomer is not included).

The terms “contact product,” “contacting,” and the like, are used herein to describe compositions wherein the components are contacted together in any order, in any manner, and for any length of time. For example, the components can be contacted by blending or mixing. Further, unless otherwise specified, the contacting of any component can occur in the presence or absence of any other component of the compositions described herein. Combining additional materials or components can be done by any suitable method. Further, the term “contact product” includes mixtures, blends, solutions, slurries, reaction products, and the like, or combinations thereof. Although “contact product” can, and often does, include reaction products, it is not required for the respective components to react with one another. Likewise, “contacting” two or more components can result in a reaction product or a reaction mixture. Consequently, depending upon the circumstances, a “contact product” can be a mixture, a reaction mixture, or a reaction product.

Although any methods and materials similar or equivalent to those described herein can be used in the practice or testing of the invention, the typical methods and materials are herein described.

All publications and patents mentioned herein are incorporated herein by reference for the purpose of describing and disclosing, for example, the constructs and methodologies that are described in the publications, which might be used in connection with the presently described invention. The publications discussed throughout the text are provided solely for their disclosure prior to the filing date of the present application. Nothing herein is to be construed as an admission that the inventors are not entitled to antedate such disclosure by virtue of prior invention.

Applicants disclose several types of ranges in the present invention. These include, but are not limited to, a range of number of atoms, a range of weight percentages, a range of mole percentages, a range of temperatures, a range of reaction times, a range of reaction pressures, a range of molecular weights, and so forth. When Applicants disclose or claim a range of any type, Applicants' intent is to disclose or claim individually each possible number that such a range could reasonably encompass, including end points of the range as well as any sub-ranges and combinations of sub-ranges encompassed therein. For example, when the Applicants disclose or claim a chemical moiety having a certain number of carbon atoms, Applicants' intent is to disclose or claim individually every possible number that such a range could encompass, consistent with the disclosure herein. For example, the disclosure that a moiety is a hydrocarbyl group having from 1 to 20 carbon atoms (i.e., a C₁-C₂₀ hydrocarbyl group), as used herein, refers to a moiety that can be selected independently from a hydrocarbyl group having 1, 2, 3, 4, 5, 6, 7, 8, 9, 10, 11, 12, 13, 14, 15, 16, 17, 18, 19, or 20 carbon atoms, as well as any range between these two numbers (for example, a hydrocarbyl group having 3 to 12 carbon atoms), and also including any combination of ranges between these two numbers (for example, a hydrocarbyl group having 1 to 4 carbon atoms and a hydrocarbyl group having 8 to 12 carbon atoms).

Similarly, another representative example follows for the percentage of cyclic oligomer compounds in an oligomer composition provided in an embodiment of this invention. By a disclosure that the oligomer composition comprises cyclic oligomer compounds in a range from 0.5 to 40 percent, Applicants intend to recite that the percentage can be 0.5, about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, or 40 percent. Additionally, the percentage can be within any range from 0.5 to 40 (for example, the percent is in a range from 2 to 20 percent), and this also includes any combination of ranges between 0.5 and 40 percent. Likewise, all other ranges disclosed herein should be interpreted in a manner similar to these two examples.

Applicants reserve the right to proviso out or exclude any individual members of any such group, including any sub-ranges or combinations of sub-ranges within the group, that can be claimed according to a range or in any similar manner, if for any reason Applicants choose to claim less than the full measure of the disclosure, for example, to account for a reference that Applicants may be unaware of at the time of the filing of the application. Further, Applicants reserve the right to proviso out or exclude any individual substituents, analogs, compounds, ligands, structures, or groups thereof, or any members of a claimed group, if for any reason Applicants choose to claim less than the full measure of the disclosure, for example, to account for a reference that Applicants may be unaware of at the time of the filing of the application.

### DETAILED DESCRIPTION OF THE INVENTION

The present disclosure provides for compositions comprising oligomers derived from bis(beta-hydroxy)polysulfides, and oligomerization processes for producing such compositions.

Oligomerization of Bis(Beta-Hydroxy) Polysulfides

Embodiments of this invention are directed to processes comprising (a) contacting an acid catalyst and a composition comprising a bis(beta-hydroxy)polysulfide; and (b) oligomerizing the bis(beta-hydroxy)polysulfide to form oligomers comprising units derived from the bis(beta-hydroxy)polysulfide. In some embodiments, compositions comprising a bis(beta-hydroxy)polysulfide may alternatively consist essentially of a bis(beta-hydroxy)polysulfide or consist of a bis(beta-hydroxy)polysulfide. In this context, “consist essentially of” means less than about 10% on an equivalent basis (or less than 8%, or less than 5%, or less than 2%) of non-catalytic materials other than bis(beta-hydroxy)polysulfides that might react with bis(beta-hydroxy)polysulfides. In an embodiment, the composition comprising, or consisting essentially of, a bis(beta-hydroxy)polysulfide may utilize a single polysulfide, or alternatively, a combination of different polysulfides. Polysulfides are described herein and these polysulfides may be utilized without limitation in the processes. In some embodiments, the process may utilize a single catalyst; or alternatively, the process may utilize more than one acid catalyst. Acid catalysts are described herein and these acid catalysts may be utilized without limitation in the processes.

In various aspects and embodiments, the oligomerization of the bis(beta-hydroxy)polysulfide may be conducted in the substantial absence of a solvent (e.g., an organic solvent). As used herein, a “substantial absence” means less than about 5% by weight, based on the weight of the bis(beta-hydroxy)polysulfide. Therefore, the oligomerization can be conducted in the presence of less than about 5% by weight, less than 4% by weight, less than 3% by weight, less than 2% by weight, or less than 1% by weight, of an organic solvent. It is also contemplated that the oligomerization can be conducted with no added solvent, for example, employing a reaction mixture consisting essentially of (or alternatively, consisting of) an acid catalyst and a composition comprising, consisting essentially of, or consisting of, a bis(beta-hydroxy)polysulfide.

In an aspect, the oligomerization of the bis(beta-hydroxy)polysulfide may be performed in the presence of a solvent. The solvent may be present in an amount up to 50% by weight based on the weight of the bis(beta-hydroxy)polysulfide. Alternatively, the oligomerization may be performed in the presence of a solvent in an amount up to 40%, up to 30%, up to 25%, up to 20%, up to 15%, or up to 10% by weight (based on the weight of the bis(beta-hydroxy)polysulfide). In an embodiment, the oligomerization may be performed in the presence of a solvent in an amount of from 10% to 50%, from 10% to 40%, from 10% to 30%, from 10% to 25%, from 10% to 20%, or from 10% to 15% by weight (based upon the weight of the bis(beta-hydroxy)polysulfide). Organic solvents which may be utilized as the oligomerization solvent are described herein, and these organic solvents may be utilized without limitation in the processes described herein.

In an aspect, water may be formed during the oligomerization of a bis(beta-hydroxy)polysulfide. In another aspect, the formed water may be removed during the oligomerization step. When an organic solvent is used during the oligomerization of the bis(beta-hydroxy)polysulfide, the water formed during oligomerization may be removed by forming an azeotrope with the organic solvent. Additionally, though not required, the removal of water can be enhanced by conducting the oligomerization at sub-atmospheric pressure. Sub-atmospheric pressures are disclosed herein and may be utilized without limitation to further describe the processes disclosed herein.

In an aspect, when the oligomerization is performed in the substantial absence of a solvent, the water formed during the oligomerization of a bis(beta-hydroxy)polysulfide may be removed by performing the oligomerization at sub-atmospheric pressures. Sub-atmospheric pressures are disclosed herein and may be utilized without limitation to further describe the processes described herein.

In an embodiment, the oligomerization can be conducted at a pressure of less than 200 Torr, less than or equal to 150 Torr, less than or equal to 100 Torr, less than or equal to 75 Torr, less than or equal to 50 Torr, or less than or equal to 25 Torr. In some embodiments, the oligomerization may be performed at a pressure ranging from 1 to 200 Torr; alternatively, from 1 to 150 Torr; alternatively, from 1 to 100 Torr; alternatively, from 1 to 75 Torr; alternatively, from 1 to 50 Torr; or alternatively, from 1 to 25 Torr.

The acid-catalyzed oligomerization of a bis(beta-hydroxy)polysulfide can be conducted at a variety of reaction temperatures, typically ranging from 60° C. to 180° C., from 100° C. to 180° C., from 110° C. to 170° C., or from 120° C. to 160° C. Alternatively, the oligomerization of the bis(beta-hydroxy)polysulfide may be conducted at a temperature from 80° C. to 150° C., from 90° C. to 150° C., or from 100° C. to 150° C.

The appropriate reaction time for the oligomerization of a bis(beta-hydroxy)polysulfide can depend upon the reaction temperature, the pKa of the acid catalyst, and the concentration of the acid catalyst, among other variables. However, without being bound by theory, Applicants believe that reaction times of 8 hours or less may lead to reduced levels of cyclic oligomer compounds in an oligomeric composition. Accordingly, in embodiments of this invention, the reaction time generally can be 8 hours or less. For example, the reaction time can be 7 hours or less, 6 hours or less, 5 hours or less, or 4 hours or less. In other embodiments, the oligomerization step may be conducted in a time period ranging from 15 minutes to 8 hours, from 30 minutes to 7 hours, from 45 minutes to 6 hours, or from 1 hour to 5 hours.

As provided herein, the disclosed process(es) produce compositions comprising, consisting essentially of, or consisting of, oligomers comprising units derived from a bis(beta-hydroxy)polysulfide. In some embodiments, the oligomers consist essentially of, or consist of, units derived from a bis(beta-hydroxy)polysulfide. The compositions of oligomers derived from a bis(beta-hydroxy)polysulfide are described herein. The description of the composition of oligomers may be utilized to further describe the process(es) for producing the composition of oligomers.

Bis(Beta-Hydroxy)Polysulfides

Embodiments of this invention are directed to processes comprising (a) contacting a composition comprising a bis(beta-hydroxy)polysulfide and an acid catalyst; and (b) oligomerizing the bis(beta-hydroxy)polysulfide to form oligomers comprising units derived from the bis(beta-hydroxy)polysulfide. In some aspects, these processes may be performed in the substantial absence of an organic solvent, while in other aspects, these processes may be performed at a reduced pressure (e.g., less than 200 Torr) and/or at an elevated temperature (e.g., from 100° C. to 180° C.).

A bis(beta-hydroxy) or di(beta-hydroxy)polysulfide has a hydroxy group attached to each carbon atom that is one carbon atom removed from a sulfur atom of the Sₓ unit.

In an embodiment, the bis(beta-hydroxy)polysulfide may have Formula I, while in another embodiment, the bis(beta-hydroxy)polysulfide may have Formula II:

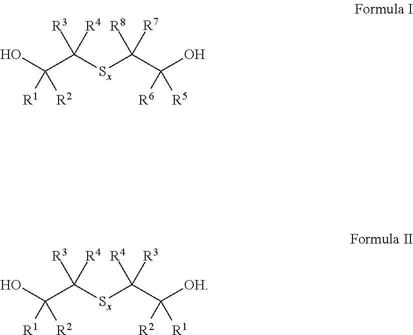

Within Formula I and II, R¹, R², R³, R⁴, R⁵, R⁶, R⁷, and R⁸, and x are independent elements of the bis(beta-hydroxy)polysulfide. The bis(beta-hydroxy)polysulfide having Formula I or Formula II may be described using any combination of R¹, R², R³, R⁴, R⁵, R⁶, R⁷, and R⁸ described herein, and any x described herein.

In an aspect, R¹, R², R³, R⁴, R⁵, R⁶, R⁷, and R⁸ of Formula I and Formula II may independently be hydrogen or a C₁-C₂₀ organyl group; alternatively, hydrogen or a C₁-C₁₅ organyl group; alternatively, hydrogen or a C₁-C₁₀ organyl group; or alternatively, hydrogen or a C₁-C₅ organyl group. In another aspect, R¹, R², R³, R⁴, R⁵, R⁶, R⁷, and R⁸ of Formula I and Formula II may independently be a hydrogen or a C₁-C₂₀ hydrocarbyl group; alternatively, hydrogen or a C₁-C₁₅ hydrocarbyl group; alternatively, hydrogen or a C₁-C₁₀ hydrocarbyl group; or alternatively, hydrogen or a C₁-C₅ hydrocarbyl group. In an aspect of the bis(beta-hydroxy)polysulfide, R¹ or R² may be joined with R³ or R⁴, and/or R⁵ or R⁶ may be joined with R⁷ or R⁸, to form a cyclic moiety. In an embodiment, when R¹ or R² is combined with R³ or R⁴, and/or R⁵ or R⁶ is combined with R⁷ or R⁸ to form a cyclic moiety, the cyclic moiety may be a C₃-C₂₀ cyclic moiety; alternatively, a C₄-C₁₅ cyclic moiety; or alternatively, a C₄-C₁₀ cyclic moiety. The number of carbons of the cyclic moiety formed by joining R¹ or R² with R³ or R⁴, and/or R⁵ or R⁶ with R⁷ or R⁸, includes the two carbon atoms to which the R groups are joined to form the cyclic moiety.

In an embodiment, each non-hydrogen R¹, R², R³, R⁴, R⁵, R⁶, R⁷, and/or R⁸ group may independently be an alkyl group, a cycloalkyl group, an aryl group, or an aralkyl group; alternatively, an alkyl group; alternatively, a cycloalkyl group; alternatively, an aryl group; or alternatively, an alkylaryl group. Generally, the alkyl group, cycloalkyl group, aryl group, or alkylaryl group which may be utilized as a non-hydrogen R¹, R², R³, R⁴, R⁵, R⁶, R⁷, and/or R⁸ group of the bis(beta-hydroxy)polysulfide having Formula I or Formula II may have the same number of carbon atoms as the hydrocarbyl group which may be utilized as a non-hydrogen R¹, R², R³, R⁴, R⁵, R⁶, R⁷, and/or R⁸ group of the bis(beta-hydroxy)polysulfide having Formula I or Formula II.

In an embodiment, a non-hydrogen R¹, R², R³, R⁴, R⁵, R⁶, R⁷, and/or R⁸ alkyl group may be a methyl group, an ethyl group, a propyl group, a butyl group, a pentyl group, a hexyl group, a heptyl group, an octyl group, a nonyl group, a decyl group, a undecyl group, a dodecyl group, a tridecyl group, a tetradecyl group, a pentadecyl group, a hexadecyl group, a heptadecyl group, an octadecyl group, or a nonadecyl group; or alternatively, a methyl group, an ethyl group, a propyl group, a butyl group, a pentyl group, a hexyl group, a heptyl group, an octyl group, a nonyl group, or a decyl group. In some embodiments, the non-hydrogen R¹, R², R³, R⁴, R⁵, R⁶, R⁷, and/or R⁸ group may be a methyl group, an ethyl group, a n-propyl group, an iso-propyl group, a n-butyl group, an iso-butyl group, a sec-butyl group, a tert-butyl group, an n-pentyl group, an iso-pentyl group, a sec-pentyl group, or a neopentyl group; alternatively, a methyl group, an ethyl group, an iso-propyl group, a tert-butyl group, or a neopentyl group; alternatively, a methyl group; alternatively, an ethyl group; alternatively, a n-propyl group; alternatively, an iso-propyl group; alternatively, a tert-butyl group; or alternatively, a neopentyl group.

In an embodiment, a non-hydrogen R¹, R², R³, R⁴, R⁵, R⁶, R⁷, and/or R⁸ group may be a cyclobutyl group, a substituted cyclobutyl group, a cyclopentyl group, a substituted cyclopentyl group, a cyclohexyl group, a substituted cyclohexyl group, a cycloheptyl group, a substituted cycloheptyl group, a cyclooctyl group, or a substituted cyclooctyl group. In some embodiments, the non-hydrogen R¹, R², R³, R⁴, R⁵, R⁶, R⁷, and/or R⁸ group may be a cyclopentyl group, a substituted cyclopentyl group, a cyclohexyl group, or a substituted cyclohexyl group. In other embodiments, the non-hydrogen R¹, R², R³, R⁴, R⁵, R⁶, R⁷, and/or R⁸ group may be a cyclobutyl group or a substituted cyclobutyl group; alternatively, a cyclopentyl group or a substituted cyclopentyl group; alternatively, a cyclohexyl group or a substituted cyclohexyl group; alternatively, a cycloheptyl group or a substituted cycloheptyl group; or alternatively, a cyclooctyl group, or a substituted cyclooctyl group. In further embodiments, the non-hydrogen R¹, R², R³, R⁴, R⁵, R⁶, R⁷, and/or R⁸ group may be a cyclopentyl group; alternatively, a substituted cyclopentyl group; a cyclohexyl group; or alternatively, a substituted cyclohexyl group. Substituents for the substituted cycloalkyl group are independently disclosed herein and may be utilized without limitation to further describe a non-hydrogen R¹, R², R³, R⁴, R⁵, R⁶, R⁷, and/or R⁸ group.

In an aspect, a non-hydrogen R¹, R², R³, R⁴, R⁵, R⁶, R⁷, and/or R⁸ group may be a phenyl group, a substituted phenyl group, a naphthyl group, or a substituted naphthyl group. In an embodiment, the non-hydrogen R¹, R², R³, R⁴, R⁵, R⁶, R⁷, and/or R⁸ group may be a phenyl group or a substituted phenyl group; alternatively, a naphthyl group or a substituted naphthyl group; alternatively, a phenyl group or a naphthyl group; or alternatively, a substituted phenyl group or a substituted naphthyl group.

In an embodiment, the substituted phenyl group which may be utilized as a non-hydrogen R¹, R², R³, R⁴, R⁵, R⁶, R⁷, and/or R⁸ group may be a 2-substituted phenyl group, a 3-substituted phenyl group, a 4-substituted phenyl group, a 2,4-disubstituted phenyl group, a 2,6-disubstituted phenyl group, 3,5-disubstituted phenyl group, or a 2,4,6-trisubstituted phenyl group. In other embodiments, the substituted phenyl group which may be utilized as a non-hydrogen R¹, R², R³, R⁴, R⁵, R⁶, R⁷, and/or R⁸ group may be a 2-substituted phenyl group, a 4-substituted phenyl group, a 2,4-disubstituted phenyl group, or a 2,6-disubstituted phenyl group; alternatively, a 3-substituted phenyl group or a 3,5-disubstituted phenyl group; alternatively, a 2-substituted phenyl group or a 4-substituted phenyl group; alternatively, a 2,4-disubstituted phenyl group or a 2,6-disubstituted phenyl group; alternatively, a 2-substituted phenyl group; alternatively, a 3-substituted phenyl group; alternatively, a 4-substituted phenyl group; alternatively, a 2,4-disubstituted phenyl group; alternatively, a 2,6-disubstituted phenyl group; alternatively, 3,5-disubstituted phenyl group; or alternatively, a 2,4,6-trisubstituted phenyl group.

In an aspect, a non-hydrogen R¹, R², R³, R⁴, R⁵, R⁶, R⁷, and/or R⁸ group may be a benzyl group or a substituted benzyl group. In an embodiment, the non-hydrogen R¹, R², R³, R⁴, R⁵, R⁶, R⁷, and/or R⁸ group may be a benzyl group; or alternatively, a substituted benzyl group.

In some embodiments, the bis(beta-hydroxy)polysulfide may have Formula III, while in other embodiments, the bis(beta-hydroxy)polysulfide may have Formula IV:

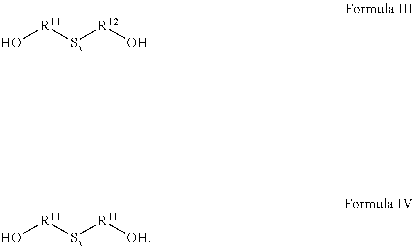

Within Formula III and IV, R¹¹, R¹², and x are independent elements of the bis(beta-hydroxy) polysulfide. The bis(beta-hydroxy)polysulfide having Formula III or Formula IV may be described using any combination of R¹¹, R¹², and x described herein.

In an aspect, R¹¹ and R¹² of Formula III and Formula IV may independently be a C₂-C₂₀ organylene group; alternatively, a C₂-C₁₅ organylene group; alternatively, a C₂-C₁₀ organylene group; or alternatively, a C₂-C₅ organylene group. In another aspect, R¹¹ and R¹² of Formula III and Formula IV may independently be a C₂-C₂₀ hydrocarbylene group; alternatively, a C₂-C₁₅ hydrocarbylene group; alternatively, a C₂-C₁₀ hydrocarbylene group; or alternatively, a C₂-C₅ hydrocarbylene group. One will appreciate that to be a bis(beta-hydroxy)polysulfide, the hydroxy group and the polysulfide group, Sₓ, would be located on adjacent carbon atoms of the organylene or hydrocarbylene group R¹¹ and/or R¹².

In an embodiment, R¹¹ and R¹² may independently be an alkylene group, a cycloalkylene group, or an arylene group; alternatively, an alkylene group; alternatively, a cycloalkylene group; or alternatively, an arylene group. Generally, when R¹¹ and/or R¹² are cyclic groups, the hydroxy group and the polysulfide group are attached to adjacent carbon atoms of the cyclic group. Generally, the alkylene group, cycloalkylene group, or arylene group which may be utilized as R¹¹ and/or R¹² of the bis(beta-hydroxy)polysulfide having Formula III or Formula IV may have the same number of carbon atoms as the organylene groups or hydrocarbylene groups which may be utilized as R¹¹ and/or R¹² of the bis(beta-hydroxy)polysulfide having Formula III or Formula IV.

In an embodiment, the alkylene group(s) which may be utilized as R¹¹ and/or R¹² of the bis(beta-hydroxy)polysulfide having Formula III or Formula IV may independently be an ethylene group, a propylene group, a butylene group, a pentylene group, a hexylene group, a heptylene group, an octylene group, a nonylene group, a decylene group, a undecylene group, a dodecylene group, a tridecylene group, a tetradecylene group, a pentadecylene group, a hexadecylene group, a heptadecylene group, an octadecylene group, or a nonadecylene group; alternatively, an ethylene group, a propylene group, a butylene group, a pentylene group, a hexylene group, a heptylene group, an octylene group, a nonylene group, or a decylene group; or alternatively, an ethylene group, a propylene group, a butylene group, or a pentylene group. In some embodiments, the alkylene group(s) which may be utilized as R¹¹ and/or R¹² of the bis(beta-hydroxy)polysulfide having Formula III or Formula IV may independently be an ethylene group; alternatively, a propylene group; alternatively, a butylene group; alternatively, a pentylene group; alternatively, a hexylene group; alternatively, a heptylene group; alternatively, an octylene group; alternatively, a nonylene group; alternatively, a decylene group; alternatively, a undecylene group; alternatively, a dodecylene group; alternatively, a tridecylene group; alternatively, a tetradecylene group; alternatively, a pentadecylene group; alternatively, a hexadecylene group; alternatively, a heptadecylene group; alternatively, an octadecylene group; or alternatively, a nonadecylene group. In other embodiments, the alkylene group(s) which may be utilized as R¹¹ and/or R¹² of the bis(beta-hydroxy)polysulfide having formula III or Formula IV may independently be an eth-1,2-ylene group, a prop-2,3-ylene group, a but-1,2-ylene group, a but-2,3-ylene group, a pent-1,2-ylene group, a pent-2,3-ylene group, a 2-methylbut-1,2-ylene group, a 2-methylbut-2,3-ylene group, a hex-1,2-ylene group, a hex-2,3-ylene group, a hex-3,4-ylene group, or a 2,3-dimethylbut-2,3-ylene group; alternatively, an eth-1,2-ylene group; alternatively, a prop-2,3-ylene group; alternatively, a but-1,2-ylene group; alternatively, a but-2,3-ylene group; alternatively, a pent-1,2-ylene group; alternatively, a pent-2,3-ylene group; alternatively, a 2-methylbut-1,2-ylene group; alternatively, a 2-methylbut-2,3-ylene group; alternatively, a hex-1,2-ylene group; alternatively, a hex-2,3-ylene group; alternatively, a hex-3,4-ylene group; or alternatively, a 2,3-dimethylbut-2,3-ylene group.

In an embodiment, R¹¹ and/or R¹² of the bis(beta-hydroxy)polysulfide having Formula III or Formula IV may independently be a cyclobutylene group, a substituted cyclobutylene group, a cyclopentylene group, a substituted cyclopentylene group, a cyclohexylene group, a substituted cyclohexylene group, a cycloheptylene group, a substituted cycloheptylene group, a cyclooctylene group, or a substituted cyclooctylene group. In some embodiments, R¹¹ and/or R¹² of the bis(beta-hydroxy)polysulfide having Formula III or Formula IV may independently be a cyclopentylene group, a substituted cyclopentylene group, a cyclohexylene group, or a substituted cyclohexylene group. In other embodiments, R¹¹ and/or R¹² may be a cyclobutylene group or a substituted cyclobutylene group; alternatively, a cyclopentylene group or a substituted cyclopentylene group; alternatively, a cyclohexylene group or a substituted cyclohexylene group; alternatively, a cycloheptylene group or a substituted cycloheptylene group; or alternatively, a cyclooctylene group or a substituted cyclooctylene group. In further embodiments, R¹¹ and/or R¹² of the bis(beta-hydroxy)polysulfide having Formula III or Formula IV may independently be a cyclopentylene group; alternatively, a substituted cyclopentylene group; alternatively, a cyclohexylene group; or alternatively, a substituted cyclohexylene group. Generally, the hydroxy group and the polysulfide group will be attached to adjacent carbon atoms of the cycloalkylene group or substituted cycloalkylene group. When R¹¹ and/or R¹² of the bis(beta-hydroxy)polysulfide having Formula III or Formula IV is a substituted cycloalkene group, the numbered position of the hydroxy group and the polysulfide group will depend upon the number and identity of the substituents of the substituted cycloalkene group.

In an embodiment, R¹¹ and/or R¹² of the bis(beta-hydroxy)polysulfide having Formula III or Formula IV may independently be a phenylene group or a substituted phenylene group. In some embodiments, R¹¹ and/or R¹² of the bis(beta-hydroxy)polysulfide having Formula III or Formula IV may independently be a phenylene group; or alternatively, a substituted phenylene group. Generally, the hydroxy group and the polysulfide group will be attached to adjacent carbon atoms of the phenylene or substituted phenylene group. When R¹¹ and/or R¹² of the bis(beta-hydroxy)polysulfide having Formula III or Formula IV is a substituted phenylene group, the numbered position of the hydroxy group and the polysulfide group will depend upon the number and identity of the substituents of the substituted phenylene group.

In an embodiment, each non-hydrogen substituent(s) for the substituted cycloalkyl group, substituted aryl group, or substituted aralkyl group which may be utilized as a non-hydrogen R¹, R², R³, R⁴, R⁵, R⁶, R⁷, and/or R⁸ group, or the substituents for the substituted cycloalkylene group or substituted arylene group which may be utilized as R¹¹ and/or R¹², may be independently selected from a halide, a C₁ to C₁₀ hydrocarbyl group, or a C₁ to C₁₀ hydrocarboxy group; alternatively, a halide or a C₁ to C₁₀ hydrocarbyl group; alternatively, a halide or a C₁ to C₁₀ hydrocarboxy group; alternatively, a C₁ to C₁₀ hydrocarbyl group or a C₁ to C₁₀ hydrocarboxy group; alternatively, a halide; alternatively, a C₁ to C₁₀ hydrocarbyl group; or alternatively, a C₁ to C₁₀ hydrocarboxy group. In another embodiment, each non-hydrogen substituent(s) for the substituted cycloalkyl group, substituted aryl group, or substituted aralkyl group which may be utilized as a non-hydrogen R¹, R², R³, R⁴, R⁵, R⁶, R⁷, and/or R⁸ group, or the substituents for the substituted cycloalkylene group or substituted arylene group which may be utilized as R¹¹ and/or R¹², may be independently selected from a halide, a C₁ to C₅ hydrocarbyl group, or a C₁ to C₅ hydrocarboxy group; alternatively, a halide or a C₁ to C₅ hydrocarbyl group; alternatively, a halide or a C₁ to C₅ hydrocarboxy group; alternatively, a C₁ to C₅ hydrocarbyl group or a C₁ to C₅ hydrocarboxy group; alternatively, a halide; alternatively, a C₁ to C₅ hydrocarbyl group; or alternatively, a C₁ to C₅ hydrocarboxy group. Specific substituent halides, substituent hydrocarbyl groups, and substituent hydrocarboxy groups are independently disclosed herein and may be utilized without limitation to further describe the substituted cycloalkyl group, substituted aryl group, or substituted aralkyl group which may be utilized as a non-hydrogen R¹, R², R³, R⁴, R⁵, R⁶, R⁷, and/or R⁸ group, or the substituents for the substituted cycloalkylene group or substituted arylene group which may be utilized as R¹¹ and/or R¹².

In an embodiment, any halide substituent of a substituted cycloalkyl group (general or specific), substituted aryl group (general or specific), substituted aralkyl group (general or specific), substituted cycloalkylene group (general or specific), or substituted arylene group (general or specific) may be a fluoride, chloride, bromide, or iodide; alternatively, a fluoride or chloride. In some embodiments, any halide substituent of a substituted cycloalkyl group (general or specific), substituted aryl group (general or specific), substituted aralkyl group (general or specific), substituted cycloalkylene group (general or specific), or substituted arylene group (general or specific) may be a fluoride; alternatively, a chloride; alternatively, a bromide; or alternatively, an iodide.

In an embodiment, any hydrocarbyl substituent of a substituted cycloalkyl group (general or specific), substituted aryl group (general or specific), substituted aralkyl group (general or specific), substituted cycloalkylene group (general or specific), or substituted arylene group (general or specific) may be an alkyl group, an aryl group, or an aralkyl group; alternatively, an alkyl group; alternatively, an aryl group; or alternatively, an aralkyl group. Generally, the alkyl, aryl, and aralkyl substituent groups may have the same number of carbon atoms as the hydrocarbyl substituent groups disclosed herein. In an embodiment, any alkyl substituent of a substituted cycloalkyl group (general or specific), substituted aryl group (general or specific), substituted aralkyl group (general or specific), substituted cycloalkylene group (general or specific), or substituted arylene group (general or specific) may be a methyl group, an ethyl group, an n-propyl group, an isopropyl group, an n-butyl group, a sec-butyl group, an isobutyl group, a tert-butyl group, an n-pentyl group, a 2-pentyl group, a 3-pentyl group, a 2-methyl-1-butyl group, a tert-pentyl group, a 3-methyl-1-butyl group, a 3-methyl-2-butyl group, or a neo-pentyl group; alternatively, a methyl group, an ethyl group, an isopropyl group, a tert-butyl group, or a neo-pentyl group; alternatively, a methyl group; alternatively, an ethyl group; alternatively, an isopropyl group; alternatively, a tert-butyl group; or alternatively, a neo-pentyl group. In an embodiment, any aryl substituent of a substituted cycloalkyl group (general or specific), substituted aryl group (general or specific), substituted aralkyl group (general or specific), substituted cycloalkylene group (general or specific), or substituted arylene group (general or specific) may be a phenyl group, a tolyl group, a xylyl group, or a 2,4,6-trimethylphenyl group; alternatively, a phenyl group; alternatively, a tolyl group, alternatively, a xylyl group; or alternatively, a 2,4,6-trimethylphenyl group. In an embodiment, any aralkyl substituent of a substituted cycloalkyl group substituted cycloalkyl group (general or specific), substituted aryl group (general or specific), substituted aralkyl group (general or specific), substituted cycloalkylene group (general or specific), or substituted arylene group (general or specific) may be a benzyl group.

In an embodiment, any hydrocarboxy substituent of a substituted cycloalkyl group (general or specific), substituted aryl group (general or specific), substituted aralkyl group (general or specific), substituted cycloalkylene group (general or specific), or substituted arylene group (general or specific) may be an alkoxy group, an aryloxy group, or an aralkoxy group; alternatively, an alkoxy group; alternatively, an aryloxy group; or alternatively, an aralkoxy group. Generally, the alkoxy, aryloxy, and aralkoxy substituent groups may have the same number of carbon atoms as the hydrocarboxy substituent groups disclosed herein. In an embodiment, any alkoxy substituent of a substituted cycloalkyl group (general or specific), substituted aryl group (general or specific), substituted aralkyl group (general or specific), substituted cycloalkylene group (general or specific), or substituted arylene group (general or specific) may be a methoxy group, an ethoxy group, an n-propoxy group, an isopropoxy group, an n-butoxy group, a sec-butoxy group, an isobutoxy group, a tert-butoxy group, an n-pentoxy group, a 2-pentoxy group, a 3-pentoxy group, a 2-methyl-1-butoxy group, a tert-pentoxy group, a 3-methyl-1-butoxy group, a 3-methyl-2-butoxy group, or a neo-pentoxy group; alternatively, a methoxy group, an ethoxy group, an isopropoxy group, a tert-butoxy group, or a neo-pentoxy group; alternatively, a methoxy group; alternatively, an ethoxy group; alternatively, an isopropoxy group; alternatively, a tert-butoxy group; or alternatively, a neo-pentoxy group. In an embodiment, any aroxy substituent of a substituted cycloalkyl group (general or specific), substituted aryl group (general or specific), substituted aralkyl group (general or specific), substituted cycloalkylene group (general or specific), or substituted arylene group (general or specific) may be a phenoxy group, a toloxy group, a xyloxy group, or a 2,4,6-trimethylphenoxy group; alternatively, a phenoxy group; alternatively, a toloxy group, alternatively, a xyloxy group; or alternatively, a 2,4,6-trimethylphenoxy group. In an embodiment, any aralkoxy substituent of a substituted cycloalkyl group (general or specific), substituted aryl group (general or specific), substituted aralkyl group (general or specific), substituted cycloalkylene group (general or specific), or substituted arylene group (general or specific) may be a benzoxy group.

In an aspect, x within Formulas I, II, III, or IV may be a number ranging from 2 to 10. In an embodiment, x within Formulas I, II, III, or IV may be a number ranging from 2 to 8; alternatively, 2 to 6; or alternatively, 2 to 4. In other embodiments, x within Formulas I, II, III, or IV may be 2; alternatively, 3; alternatively, 4; alternatively, 5; alternatively, 6; alternatively, 7; alternatively, 8; alternatively, 9; or alternatively, 10.

As would be recognized to those of skill in the art, commercially available polysulfides typically include polysulfides having different values of x. For example, the commercially available bis(beta-hydroxy)polysulfide dihydroxydiethyl disulfide (also referred to as dithiodiglycol) may contain the polysulfide having the formula HOC₂H₄S₂C₂H₄OH and some polysulfide having the formula HOC₂H₄S₃C₂H₄OH. Consequently, the value x of a composition comprising, consisting essentially of, or that consists of, bis(beta-hydroxy)polysulfides may be described as having an average value of x. Generally, the average value of x of a composition comprising, consisting essentially of, or that consists of, bis(beta-hydroxy)polysulfides is not necessarily an integer. For example, x can be 2.05, or x can be 2.5. In an aspect, the average value of x for the bis(beta-hydroxy) polysulfides of the composition comprising, consisting essentially of, or consisting of, bis(beta-hydroxy)polysulfides may range from 2 to 10; alternatively, from 2 to 8; alternatively, from 2 to 6; alternatively, from 2 to 5; alternatively, from 2 to 4.5; alternatively, from 2 to 4; alternatively from 2 to 3.5; or alternatively, from 2 to 3. In some embodiments, the average value of x for the bis(beta-hydroxy)polysulfides of the composition comprising, consisting essentially of, or consisting of, bis(beta-hydroxy)polysulfides may be about 2; alternatively, about 2.5; alternatively, about 3; alternatively, about 3.5; or alternatively, about 4.

Generally, the polysulfides of the composition comprising, consisting essentially of, or consisting of, bis(beta-hydroxy)polysulfides may be any bis(beta-hydroxy)polysulfide disclosed herein or may be a combination of any bis(beta-hydroxy)polysulfides disclosed herein. In some particular non-limiting embodiments, the bis(beta-hydroxy)polysulfides of the composition comprising, consisting essentially of, or consisting of, bis(beta-hydroxy) polysulfides may have the Formula II where R¹, R², R³, and R⁴ are hydrogen (or Formula IV where R¹² is an eth-1,2-ylene group); e.g., HOC₂H₄SₓC₂H₄OH. Generally, the average value of x for the composition comprising, consisting essentially of, or consisting of, HOC₂H₄SₓC₂H₄OH may be any average x disclosed herein. In some non-limiting embodiments, the bis(beta-hydroxy)polysulfides of the composition comprising, consisting essentially of, or consisting of, bis(beta-hydroxy)polysulfides may be HOC₂H₄SₓC₂H₄OH where x has an average value from 2 to 5; alternatively, HOC₂H₄SₓC₂H₄OH where x has an average value from 2 to 4; alternatively, HOC₂H₄SₓC₂H₄OH where x has an average value from 2 to 3; or alternatively, HOC₂H₄SₓC₂H₄OH where x has an average value of about 2.

Acid Catalyst

In some embodiments, the catalyst employed in the oligomerization of a bis(beta-hydroxy)polysulfide can be an acid catalyst. For example, the acid catalyst may have a pKa of less than or equal to 4. Alternatively, the pKa of the acid catalyst can be less than or equal to 3, and in other embodiments, the pKa can be less than or equal to 2.

In an embodiment, the acid catalyst may comprise, consist essentially of, or consist of, a mineral acid. Suitable mineral acids can include, but are not limited to, hydrobromic acid, hydrochloric acid, nitric acid, sulfuric acid, phosphoric acid, and the like, or combinations thereof. In some embodiments, the mineral acid may be hydrobromic acid; alternatively, hydrochloric acid; alternatively, nitric acid; alternatively, sulfuric acid; or alternatively, phosphoric acid.

In another embodiment, the acid catalyst can comprise, consist essentially of, or consist of, an organic acid or an inorganic acid; alternatively, an organic acid; or alternatively, an inorganic acid. In certain embodiments, the organic acid may be a C₁ to C₃₀ organic acid; alternatively, a C₁ to C₂₀ organic acid; alternatively, a C₁ to C₁₅ organic acid; alternatively, a C₁ to C₁₀ organic acid; or alternatively, a C₁ to C₅ organic acid. An illustrative and non-limiting example of an inorganic acid that can be employed in oligomerizations of bis(beta-hydroxy)polysulfides may be sulfamic acid. The organic acid can comprise, consist essentially of, or consist of, a carboxylic acid or an organic sulfonic acid; alternatively, a carboxylic acid; or alternatively, an organic sulfonic acid.

Suitable carboxylic acids may have the same number of carbon atoms as the organic acid disclosed herein. Examples of carboxylic acids that can be employed as acid catalysts in embodiments of the present invention include, but are not limited to, benzoic acid, a nitro substituted benzoic acid, a halo substituted benzoic acid, formic acid, acetic acid, propionic acid, butyric acid, dicarboxylic acids such as oxalic acid, a halo substituted acetic acid such as trifluoroacetic acid and trichloroacetic acid, and the like, or combinations thereof. In some embodiments, the carboxylic acid may be benzoic acid, a nitro substituted benzoic acid, a halo substituted benzoic acid; alternatively, a nitro substituted benzoic acid or a halo substituted benzoic acid; alternatively, benzoic acid; alternatively, a nitro substituted benzoic acid; or alternatively, a halo substituted benzoic acid, In other embodiments, the carboxylic acid may be acetic acid; alternatively, a halo substituted acetic acid; alternatively, oxalic acid; alternatively, trifluoroacetic acid; or alternatively, trichloroacetic acid. Substituent halogens are independently disclosed herein (e.g., as halogen/halide substituents for a substituted cycloalkyl group, substituted aryl group, substituted aralkyl group, substituted cycloalkylene group, or substituted arylene group) and may be utilized without limitation to further describe the halo substituted benzoic acid or halo substituted acetic acid which may be utilized as the acid catalyst.

In an embodiment, the organic sulfonic acid may have the same number of carbon atoms as the organic acid disclosed herein. In some embodiments, the organic sulfonic acid may be an aryl sulfonic acid or an alkyl sulfonic acid; alternatively; an aryl sulfonic acid; or alternatively, an alkyl sulfonic acid. Suitable aryl sulfonic acids include, but are not limited to, benzene sulfonic acid, a substituted benzene sulfonic acid, naphthalene sulfonic acid, or a substituted naphthalene sulfonic acid; alternatively, benzene sulfonic acid or naphthalene sulfonic acid; alternatively, benzene sulfonic acid; alternatively, a substituted benzene sulfonic acid; alternatively, naphthalene sulfonic acid; or alternatively, a substituted naphthalene sulfonic acid. Substituent groups are independently disclosed herein (e.g., as substituents for a substituted cycloalkyl group, substituted aryl group, substituted aralkyl group, substituted cycloalkylene group, or substituted arylene group) and may be utilized without limitation to further describe the substituted benzene sulfonic acid or substituted naphthalene sulfonic acid which may be utilized as the acid catalyst.

In an embodiment, the alkyl sulfonic acid may be methane sulfonic acid. In an embodiment, the sulfonic acid may be benzene sulfonic acid, toluene sulfonic acid (ortho, meta, and/or para), dodecylbenzene sulfonic acid, naphthalene sulfonic acid, dinonylnaphthalene disulfonic acid, methane sulfonic acid, or any combination thereof. In an embodiment, the sulfonic acid may be benzene sulfonic acid, toluene sulfonic acid (ortho, meta, and/or para), dodecylbenzene sulfonic acid, naphthalene sulfonic acid, or dinonylnaphthalene disulfonic acid; alternatively, benzene sulfonic acid or toluene sulfonic acid (ortho, meta, and/or para); alternatively, naphthalene sulfonic acid or dinonylnaphthalene disulfonic acid; alternatively, benzene sulfonic acid; alternatively, toluene sulfonic acid (ortho, meta, and/or para); alternatively, dodecylbenzene sulfonic acid; alternatively, naphthalene sulfonic acid; alternatively, dinonylnaphthalene disulfonic acid; or alternatively, methane sulfonic acid.

In oligomerization processes disclosed herein, the acid catalyst may be present in a range of from 0.05 to 6 weight % (based on the weight of the bis(beta-hydroxy)polysulfide), such as, for example, from 0.05 to 4 weight %, from 0.05 to 3 weight %, from 0.05 to 2 weight %, from 0.05 to 1 weight %, from 0.075 to 0.75 weight %, or from 0.1 to 0.5 weight %. In other embodiments, the acid catalyst may be present in a range of from 0.05 to 6 mole (based on the total moles of the bis(beta-hydroxy)polysulfide), such as, from 0.05 to 4 mole %, from 0.05 to 3 mole %, from 0.05 to 2 mole %, from 0.05 to 1 mole %, from 0.075 to 0.75 mole %, or from 0.1 to 0.5 mole %.

### Oligomerization Solvent

Illustrative organic solvents which may be utilized for the oligomerization of the bis(beta-hydroxy)polysulfide include hydrocarbons, halogenated hydrocarbons, and combinations thereof. Hydrocarbon and halogenated hydrocarbon solvents can include, for example, aliphatic hydrocarbons, aromatic hydrocarbons, petroleum distillates, halogenated aliphatic hydrocarbons, halogenated aromatic hydrocarbons, or combinations thereof; alternatively aliphatic hydrocarbons, aromatic hydrocarbons, halogenated aliphatic hydrocarbons, halogenated aromatic hydrocarbons, and combinations thereof; alternatively, aliphatic hydrocarbons; alternatively, aromatic hydrocarbons; alternatively, halogenated aliphatic hydrocarbons; or alternatively, halogenated aromatic hydrocarbons.

Aliphatic hydrocarbons which may be useful as the oligomerization solvent include C₃ to C₂₀ aliphatic hydrocarbons; alternatively C₄ to C₁₅ aliphatic hydrocarbons; or alternatively, C₅ to C₁₀ aliphatic hydrocarbons. The aliphatic hydrocarbons may be cyclic or acyclic and/or may be linear or branched, unless otherwise specified.

Non-limiting examples of suitable acyclic aliphatic hydrocarbon solvents that may be utilized singly or in any combination include pentane (n-pentane or a mixture of linear and branched C₅ acyclic aliphatic hydrocarbons), hexane (n-hexane or mixture of linear and branched C₆ acyclic aliphatic hydrocarbons), heptane (n-heptane or mixture of linear and branched C₇ acyclic aliphatic hydrocarbons), octane (n-octane or a mixture of linear and branched C₈ acyclic aliphatic hydrocarbons), and combinations thereof; alternatively, pentane (n-pentane or a mixture of linear and branched C₅ acyclic aliphatic hydrocarbons), hexane (n-hexane or mixture of linear and branched C₆ acyclic aliphatic hydrocarbons), heptane (n-heptane or mixture of linear and branched C₇ acyclic aliphatic hydrocarbons), octane (n-octane or a mixture of linear and branched C₈ acyclic aliphatic hydrocarbons), and combinations thereof; hexane (n-hexane or a mixture of linear and branched C₆ acyclic aliphatic hydrocarbons), heptane (n-heptane or mixture of linear and branched C₇ acyclic aliphatic hydrocarbons), octane (n-octane or a mixture of linear and branched C₈ acyclic aliphatic hydrocarbons), and combinations thereof; alternatively, pentane (n-pentane or a mixture of linear and branched C₅ acyclic aliphatic hydrocarbons); alternatively, hexane (n-hexane or mixture of linear and branched C₆ acyclic aliphatic hydrocarbons); alternatively, heptane (n-heptane or mixture of linear and branched C₇ acyclic aliphatic hydrocarbons); or alternatively, octane (n-octane or a mixture of linear and branched C₈ acyclic aliphatic hydrocarbons).

Non-limiting examples of suitable cyclic aliphatic hydrocarbon solvents include cyclohexane, methyl cyclohexane, and combinations thereof; alternatively cyclohexane; or alternatively, methylcyclohexane.

Aromatic hydrocarbons which may be useful as a solvent include C₆ to C₂₀ aromatic hydrocarbons; alternatively, C₆ to C₂₀ aromatic hydrocarbons; or alternatively, C₆ to C₁₀ aromatic hydrocarbons. Non-limiting examples of suitable aromatic hydrocarbons that may be utilized singly or in any combination include benzene, toluene, xylene (including ortho-xylene, meta-xylene, para-xylene, or mixtures thereof), and ethylbenzene, or combinations thereof; alternatively, benzene; alternatively, toluene; alternatively, xylene (including ortho-xylene, meta-xylene, para-xylene or mixtures thereof); or alternatively, ethylbenzene.

Halogenated aliphatic hydrocarbons which may be useful as a solvent include C₂ to C₁₅ halogenated aliphatic hydrocarbons; alternatively, C₂ to C₁₀ halogenated aliphatic hydrocarbons; or alternatively, C₂ to C₅ halogenated aliphatic hydrocarbons. The halogenated aliphatic hydrocarbons may be cyclic or acyclic and/or may be linear or branched, unless otherwise specified. Non-limiting examples of suitable halogenated aliphatic hydrocarbons which may be utilized include chloroform, carbon tetrachloride, dichloroethane, trichloroethane, and combinations thereof; alternatively, chloroform, dichloroethane, trichloroethane, and combinations thereof; alternatively, methylene chloride; alternatively, chloroform; alternatively, carbon tetrachloride; alternatively, dichloroethane; or alternatively, trichloroethane.

Halogenated aromatic hydrocarbons which may be useful as a solvent include C₆ to C₂₀ halogenated aromatic hydrocarbons; alternatively, C₆ to C₁₅ halogenated aromatic hydrocarbons; or alternatively, C₆ to C₁₀ halogenated aromatic hydrocarbons. Non-limiting examples of suitable halogenated aromatic hydrocarbons include chlorobenzene, dichlorobenzene, and combinations thereof; alternatively, chlorobenzene; or alternatively, dichlorobenzene.

### Oligomer Compositions

Embodiments of the present invention also are directed to compositions comprising, consisting essentially of, or consisting of, oligomers derived from a bis(beta-hydroxy) polysulfide. In some embodiments, the compositions include the composition produced by any process described herein. For instance, the present invention provides a composition (or oligomers) produced by a process comprising (a) contacting an acid catalyst and a composition comprising (or consisting essentially of, or consisting of) a bis(beta-hydroxy) polysulfide; and (b) oligomerizing the bis(beta-hydroxy)polysulfide to form oligomers comprising units derived from the bis(beta-hydroxy)polysulfide.

In another embodiment, a composition is provided, and this composition comprises, consists essentially of, or consists of, oligomers derived from an acid-catalyzed oligomerization of a bis(beta-hydroxy)polysulfide. For example, in a non-limiting aspect, the acid catalyzed oligomerization may be performed as described herein, for instance, using an acid catalyst in a range of from 0.05 to 6 weight % (based on the weight of the bis(beta-hydroxy)polysulfide), and/or in the substantial absence of an organic solvent, and/or under sub-atmospheric pressure conditions (e.g., a pressure in a range from 1 to 100 Torr), and/or at a reaction temperature in a range from 60° C. to 180° C. (e.g., from 100° C. to 160° C.), and/or for a reaction time in a range from 45 minutes to 6 hours. Other aspects of the oligomerization process are readily apparent from the present disclosure.

In yet another embodiment, a composition comprising oligomers is provided, and in this embodiment, the oligomers comprise units derived from a bis(beta-hydroxy)polysulfide. In some embodiments, the oligomers may consist essentially of, or consist of, units derived from a bis(beta-hydroxy)polysulfide. Bis(beta-hydroxy)polysulfides are described herein and may be utilized without limitation to further describe the oligomers. For instance, the bis(beta-hydroxy)polysulfide can comprise (or consist essentially of, or consist of) dihydroxydiethyl disulfide, also referred to as dithiodiglycol, with the following formula: HOC₂H₄S₂C₂H₄OH.

It is contemplated that any composition comprising, consisting essentially of, or consisting of, oligomers comprising, consisting essentially of, or consisting of, units derived from a bis(beta-hydroxy)polysulfide, or the oligomers of such composition, disclosed herein may have less than 45% cyclic oligomer compounds. As used herein, the “% cyclics” means the “area percentage” of cyclic oligomeric compounds in the composition, inclusive of residual monomer, as determined via HPLC by the analytical HPLC procedure described herein. The cyclic oligomer compounds may contain two or more units derived from the respective bis(beta-hydroxy)polysulfide material. In some embodiments, the composition and/or the oligomers of the composition may comprise less than 40% cyclic oligomer compounds; alternatively, less than 35% cyclic oligomer compounds; alternatively, less than 30% cyclic oligomer compounds; alternatively, less than 25% cyclic oligomer compounds; alternatively, less than 20% cyclic oligomer compounds; alternatively, less than 15% cyclic oligomer compounds; or alternatively, less than 10% cyclic oligomer compounds. In other embodiments, the composition comprising, consisting essentially of, or consisting of, oligomers comprising, consisting essentially of, or consisting of, units derived from bis(beta-hydroxy)polysulfide and/or the oligomers of the composition may comprise from 0.5 to 40% cyclic oligomer compounds, such as, for example, from 1 to 35% cyclic oligomer compounds, from 1 to 30% cyclic oligomer compounds, from 1 to 25% cyclic oligomer compounds, from 1 to 20% cyclic oligomer compounds, from 2 to 20% cyclic oligomer compounds, or from 2 to 15% cyclic oligomer compounds.

In an aspect, the maximum % cyclics of the oligomer composition and/or the oligomers of the composition can be less than or equal to 14% cyclic oligomer compounds; alternatively, 13% cyclic oligomer compounds; alternatively, 12% cyclic oligomer compounds; alternatively, 10% cyclic oligomer compounds; alternatively, 9% cyclic oligomer compounds; alternatively, 8% cyclic oligomer compounds; alternatively, 7% cyclic oligomer compounds; alternatively, 6% cyclic oligomer compounds; or alternatively, 5% cyclic oligomer compounds. In an aspect, the minimum % cyclics of the oligomer composition and/or the oligomers of the composition can be greater than or equal to 0.1% cyclic oligomer compounds; alternatively, 0.25% cyclic oligomer compounds; alternatively, 0.5% cyclic oligomer compounds; alternatively, 0.75% cyclic oligomer compounds; or alternatively, 1% cyclic oligomer compounds. In some embodiments, the % cyclics of the oligomer composition and/or the oligomers of the composition can range from any minimum % cyclics described herein to any maximum % cyclics described herein. In some non-limiting embodiments, the % cyclics of the composition and/or the oligomers of the composition can range from 0.1% cyclic oligomer compounds to 14% cyclic oligomer compounds; alternatively, range from 0.5% cyclic oligomer compounds to 10% cyclic oligomer compounds; alternatively, range from 0.1% cyclic oligomer compounds to 6% cyclic oligomer compounds; or alternatively, range from 0.5% cyclic oligomer compounds to 6% cyclic oligomer compounds. Other ranges for the % cyclic compounds in the oligomer composition and/or the oligomers of the composition are readily apparent from the present disclosure.

Compositions comprising, consisting essentially of, or consisting of, oligomers comprising, consisting essentially of, or consisting of, units derived from bis(beta-hydroxy) polysulfide and oligomers of the composition of this invention additionally may be characterized by a number-average molecular weight (Mₙ) and/or by a weight-average molecular weight (M_{w}), as determined via GPC by the procedure described herein. In an embodiment, compositions comprising, consisting essentially of, or consisting of, oligomers comprising, consisting essentially of, or consisting of, units derived from bis(beta-hydroxy) polysulfide and oligomers of the composition of this invention can have a maximum Mₙ and/or M_{w} (as determined via GPC by the procedure described herein) of less than or equal to 50,000 g/mol; alternatively, 25,000 g/mol; alternatively, 15,000 g/mol; alternatively, 12,500 g/mol; alternatively, 10,000 g/mol; alternatively, 9,500 g/mol; alternatively, 9,000 g/mol; alternatively, 8,000 g/mol; alternatively, 7,500 g/mol; alternatively, 7,000 g/mol; alternatively, 6,500 g/mol; alternatively, 6,000 g/mol; alternatively, 5,500 g/mol; alternatively, 5,000 g/mol; alternatively, 4,500 g/mol; alternatively, 4,000 g/mol; alternatively, 3,500 g/mol; alternatively, 3,000 g/mol, alternatively, 2,500 g/mol; alternatively, 2,000 g/mol; alternatively, 1,500 g/mol; alternatively, 1,250 g/mol; alternatively, 1,000 g/mol; alternatively, 800 g/mol; alternatively, 700 g/mol; or alternatively, 600 g/mol. In an embodiment, compositions comprising, consisting essentially of, or consisting of, oligomers comprising, consisting essentially of, or consisting of, units derived from bis(beta-hydroxy)polysulfide and oligomers of the composition of this invention can have a minimum Mₙ and/or M_{w} (as determined via GPC by the procedure described herein) of greater than or equal to 250 g/mol; alternatively, 400 g/mol; alternatively, 500 g/mol; alternatively, 600 g/mol; alternatively, 700 g/mol; alternatively, 800 g/mol; alternatively, 1,000 g/mol; alternatively, 1,500 g/mole; alternatively, 2,000 g/mol; alternatively, 2,500 g/mol; alternatively, 3,000 g/mol; alternatively, 3,500 g/mol; alternatively, 4,000 g/mol; alternatively, 4,500 g/mol; alternatively, 5,000 g/mol; alternatively, 5,500 g/mol; alternatively, 6,000 g/mol, alternatively, 7,000 g/mol; alternatively, 8,000 g/mol; alternatively, 9,000 g/mol; or alternatively, 10,000 g/mol. In some embodiments, the compositions comprising, consisting essentially of, or consisting of, oligomers comprising, consisting essentially of, or consisting of, units derived from bis(beta-hydroxy)polysulfide and oligomers of the composition of this invention can range from any minimum Mₙ and/or M_{w} described herein to any maximum Mₙ and/or M_{w} described herein (i.e., where the maximum Mₙ and/or M_{w} is greater than the minimum Mₙ and/or M_{w}).

In some non-limiting embodiments, the compositions comprising, consisting essentially of, or consisting of, oligomers comprising, consisting essentially of, or consisting of, units derived from bis(beta-hydroxy)polysulfide can have a Mₙ and/or M_{w} in a range from 250 to 15,000 g/mol. In some embodiments, the compositions comprising, consisting essentially of, or consisting of, oligomers comprising, consisting essentially of, or consisting of, units derived from a bis(beta-hydroxy)polysulfide can have a Mₙ and/or M_{w} in a range from 250 to 10,000 g/mol; alternatively, from 250 to 7,500 g/mol; alternatively, from 250 to 5,000 g/mol; alternatively, from 400 to 10,000 g/mol; alternatively, from 350 to 6,000 g/mol; alternatively, from 400 to 7,500 g/mol; alternatively, from 400 to 5,000 g/mol; alternatively, from 500 to 7,500 g/mol; alternatively, from 500 to 5,000 g/mol; alternatively, from 500 to 4,000 g/mol; alternatively, from 400 to 800 g/mol; alternatively, from 800 to 1,250 g/mol; alternatively, from 900 to 2,500 g/mol; alternatively, from 1,250 to 2000 g/mol; alternatively, from 1,250 to 2,500 g/mol; alternatively, from 2,500 to 4,000 g/mol; alternatively, from 4,000 to 5,500 g/mol; alternatively, from 4,500 to 6,000 g/mol; or alternatively, from 4,000 to 7,000 g/mol. Other Mₙ and/or M_{w} ranges for the compositions comprising, consisting essentially of, or consisting of, oligomers comprising, consisting essentially of, or consisting of, units derived from bis(beta-hydroxy)polysulfide are readily apparent from the present disclosure. Likewise, in some embodiments, the oligomers of the composition comprising, consisting essentially of, or consisting of, oligomers comprising, consisting essentially of, or consisting of, units derived from a bis(beta-hydroxy)polysulfide can have a Mₙ and/or M_{w} in a range from 250 to 15,000 g/mol; alternatively, from 250 to 10,000 g/mol; alternatively, from 250 to 7,500 g/mol; alternatively, from 350 to 10,000 g/mol; alternatively, from 350 to 6,000 g/mol; alternatively, from 400 to 7,500 g/mol; alternatively, from 400 to 5,000 g/mol; alternatively, from 500 to 7,500 g/mol; alternatively, from 500 to 5,000 g/mol; alternatively, from 500 to 4,000 g/mol; alternatively, from 500 to 800 g/mol; alternatively, from 800 to 1,250 g/mol; alternatively, from 900 to 2,500 g/mol; alternatively, from 1,250 to 2000 g/mol; alternatively, from 1,250 to 2,500 g/mol; alternatively, from 2,500 to 4,000 g/mol; alternatively, from 4,000 to 5,500 g/mol; alternatively, from 4,500 to 6,000 g/mol; or alternatively, from 4,000 to 7,000 g/mol. Other Mₙ and/or M_{w} ranges for the oligomers of the compositions comprising, consisting essentially of, or consisting of, oligomers comprising, consisting essentially of, or consisting of, units derived from bis(beta-hydroxy)polysulfide are readily apparent from the present disclosure.

An illustrative and non-limiting composition encompassed by this invention comprises oligomers comprising, consisting essentially of, or consisting of, units derived from a bis(beta-hydroxy)polysulfide, the bis(beta-hydroxy)polysulfide comprising dihydroxydiethyl disulfide. This composition, and the oligomers of this composition, may be characterized as having a Mₙ and/or M_{w} in a range from 250 to 10,000 g/mol; alternatively, from 250 to 7,500 g/mol; alternatively, from 250 to 5,000 g/mol; alternatively, from 350 to 10,000 g/mol; alternatively, from 350 to 6,000 g/mol; alternatively, from 400 to 7,500 g/mol; alternatively, from 400 to 5,000 g/mol; alternatively, from 500 to 7,500 g/mol; alternatively, from 500 to 5,000 g/mol; alternatively, from 500 to 4,000 g/mol; alternatively, from 400 to 800 g/mol; alternatively, from 800 to 1,250 g/mol; alternatively, from 900 to 2,500 g/mol; alternatively, from 1,250 to 2,000 g/mol; alternatively, from 1,250 to 2,500 g/mol; alternatively, from 2,500 to 4,000 g/mol; alternatively, from 4,000 to 5,500 g/mol; alternatively, from 4,500 to 6,000 g/mol; or alternatively, from 4,000 to 7,000 g/mol. Hence, an illustrative composition comprising oligomers of dihydroxydiethyl disulfide (or the oligomers of the composition) may be characterized as having from 0.5 to 40% cyclic oligomer compounds and a Mₙ and/or M_{w} in a range from 250 to 10,000 g/mol. Another illustrative and non-limiting composition (or oligomers of the composition) may be characterized as having from 1 to 25% cyclic oligomer compounds and a Mₙ and/or M_{w} in a range from 350 to 6,000 g/mol. Yet another illustrative composition (or oligomers of the composition) may be characterized as having from 2 to 20% cyclic oligomer compounds and a Mₙ and/or M_{w} in a range from 500 to 5,000 g/mol. In still another illustrative composition (or oligomers of the composition) may be characterized as having from 0.5 to 6% cyclic oligomer compounds and a Mₙ in a range from 250 to 800 g/mol; alternatively, 0.5 to 6% cyclic oligomer compounds and a Mₙ in a range from 400 to 800 g/mol; alternatively, 0.5 to 6% cyclic oligomer compounds and a Mₙ in a range from 250 to 1,000 g/mol; alternatively, 0.5 to 6% cyclic oligomer compounds and a Mₙ in a range from 500 to 1,000 g/mol; alternatively, 1 to 10% cyclic oligomer compounds and a Mₙ in a range from 800 to 1,250 g/mol; alternatively, 1 to 14% cyclic oligomer compounds and a Mₙ in a range from 1,250 to 2,000 g/mol; or alternatively, 1 to 15% cyclic oligomer compounds and a Mₙ in a range from 1,250 to 2,500 g/mol. Other combinations of % cyclic oligomer compounds and Mₙ are readily apparent from the present disclosure. Moreover, additional illustrative compositions (or oligomers of the composition) may be characterized as having from 0.5 to 6% cyclic oligomer compounds and a M_{w} in a range from 500 to 2,500 g/mol; alternatively, 0.5 to 6% cyclic oligomer compounds and a M_{w} in a range from 900 to 2,500 g/mol; alternatively, 1 to 10% cyclic oligomer compounds and a M_{w} in a range from 2,500 to 4,000 g/mol; alternatively, 1 to 15% cyclic oligomer compounds and a M_{w} in a range from 4,000 to 5,500 g/mol; alternatively, 1 to 15% cyclic oligomer compounds and a M_{w} in a range from 4,000 to 6,000 g/mol; or alternatively, 1 to 15% cyclic oligomer compounds and a M_{w} in a range from 4,000 to 7,000 g/mol. Other combinations of % cyclic oligomer compounds and M_{w} are readily apparent from the present disclosure.

In an embodiment, the % cyclics in the oligomer composition can be correlated to the M_{w} of any composition (inclusive of residual monomer) described herein. Generally, the M_{w} can be, for instance, from 250 to 15,000 g/mol, from 350 to 6,000 g/mol, from 800 to 10,000 g/mol, or from 800 to 7,000 g/mol, among others that are readily apparent from the present disclosure. In one aspect, the % cyclics can have a maximum value defined by the equation:

% cyclics≦(4.18×10⁻⁵*M_{w})+1.62×10⁻²; alternatively,

% cyclics≦(3.94×10⁻⁵*M_{w})+1.53×10⁻²; alternatively,

% cyclics≦(3.71×10⁻⁵*M_{w})+1.44×10⁻²; or alternatively,

% cyclics≦(3.48×10⁻⁵*M_{w})+1.35×10⁻².

In another aspect, the % cyclics in the oligomer composition can have a minimum value defined by the equation:

% cyclics≧(2.32×10⁻⁶*M_{w})+9.00×10⁻⁴; alternatively,

% cyclics≧(4.64×10⁻⁶*M_{w})+1.8×10⁻³; alternatively,

% cyclics≧(6.96×10⁻⁶*M_{w})+2.70×10⁻³; or alternatively,

% cyclics≧(9.28×10⁻⁶*M_{w})+3.6×10⁻³.

In some aspects, the % cyclics in the oligomer composition, inclusive of residual monomer, can be less than or equal to any maximum percent cyclic value described herein. In other aspects, the % cyclics in the oligomer composition can be any value ranging from any minimum % cyclics value described herein to any maximum % cyclics value described herein. For example, in some non-limiting aspects, the % cyclics in the oligomer composition can be correlated to the M_{w} of the composition, inclusive of residual monomer, and have a value in a range from:

% cyclics≧(2.32×10⁻⁶*M_{w})+9.00×10⁻⁴ to % cyclics≦(4.18×10⁻⁵*M_{w})+1.62×10⁻²;

alternatively, from % cyclics≧(4.64×10⁻⁶*M_{w})+1.8×10⁻³ to

% cyclics≦(4.18×10⁻⁵*M_{w})+1.62×10⁻²; or alternatively, from

% cyclics≧(4.64×10⁻⁶*M_{w})+1.8×10⁻³ to % cyclics≦(3.94×10⁻⁵*M_{w})+1.53×10⁻².

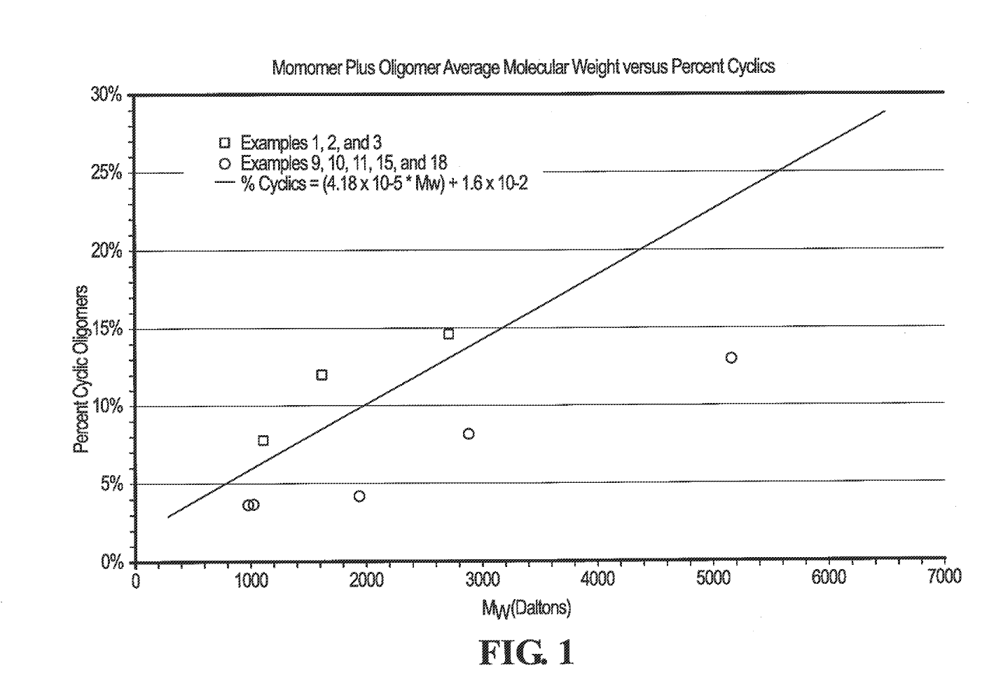

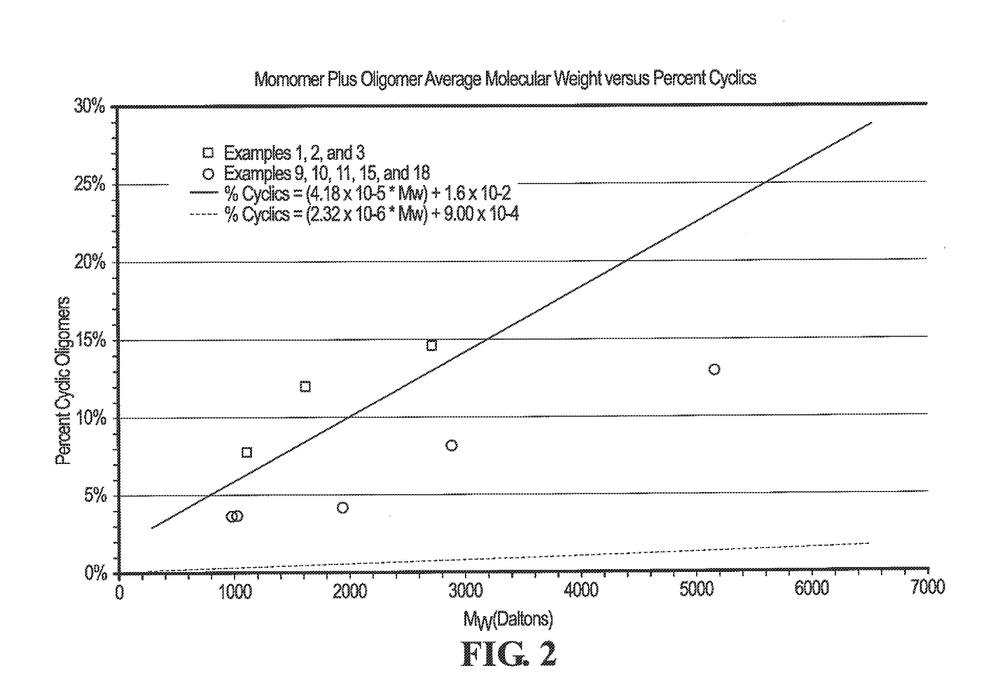

Other values and ranges for the % cyclic compounds in the oligomer composition based on the M_{w} of the oligomer composition are readily apparent from the present disclosure, e.g., as illustrated in FIGS. 1-2, to be discussed further in the Example section.

In another embodiment, the % cyclics of the composition can be correlated to the M_{w} of the oligomers of the composition, exclusive of residual monomer. Generally, this M_{w} can be, for instance, from 250 to 15,000 g/mol, from 350 to 6,000 g/mol, from 800 to 10,000, or from 800 to 7,000, among others that are readily apparent from the present disclosure. In this aspect, the % cyclics can have a maximum value defined by the equation:

% cyclics≦(4.19×10⁻⁵*M_{w})+1.04×10⁻²; alternatively,

% cyclics≦(3.96×10⁻⁵*M_{w})+9.81×10⁻³; alternatively,

% cyclics≦(3.73×10⁻⁵*M_{w})+9.23×10⁻³; or alternatively,

% cyclics≦(3.50×10⁻⁵*M_{w})+8.65×10⁻³.

In another aspect, the % cyclics of the composition can have a minimum value defined by the equation:

% cyclics≧(2.33×10⁻⁶*M_{w})+5.77×10⁻⁴; alternatively,

% cyclics≧(4.66×10⁻⁶*M_{w})+1.15×10⁻³; alternatively,

% cyclics≧(6.99×10⁻⁶*M_{w})+1.73×10⁻³; or alternatively,

% cyclics≧(9.32×10⁻⁶*M_{w})+2.31×10⁻³.

In some aspects, the % cyclics of the composition can be less than or equal to any maximum % cyclics value described herein. In other aspects, the % cyclics of the composition can be any value ranging from any minimum % cyclics value described herein to any maximum % cyclics value described herein. For example, in some non-limiting aspects, the % cyclics in the oligomer composition can be correlated to the M_{w} of the oligomers of the composition, exclusive of residual monomer, and have a value in a range from:

% cyclics≧(2.33×10⁻⁶*M_{w})+5.77×10⁻⁴ to % cyclics≦(4.19×10⁻⁵*M_{w})+1.04×10⁻²;

alternatively, from % cyclics≧(4.66×10⁻⁶*M_{w})+1.15×10⁻³ to

% cyclics≦(4.19×10⁻⁵*M_{w})+1.04×10⁻²; or alternatively, from

% cyclics≧(4.66×10⁻⁶*M_{w})+1.15×10⁻³ to % cyclics≦(3.96×10⁻⁵*M_{w})+9.81×10⁻³.

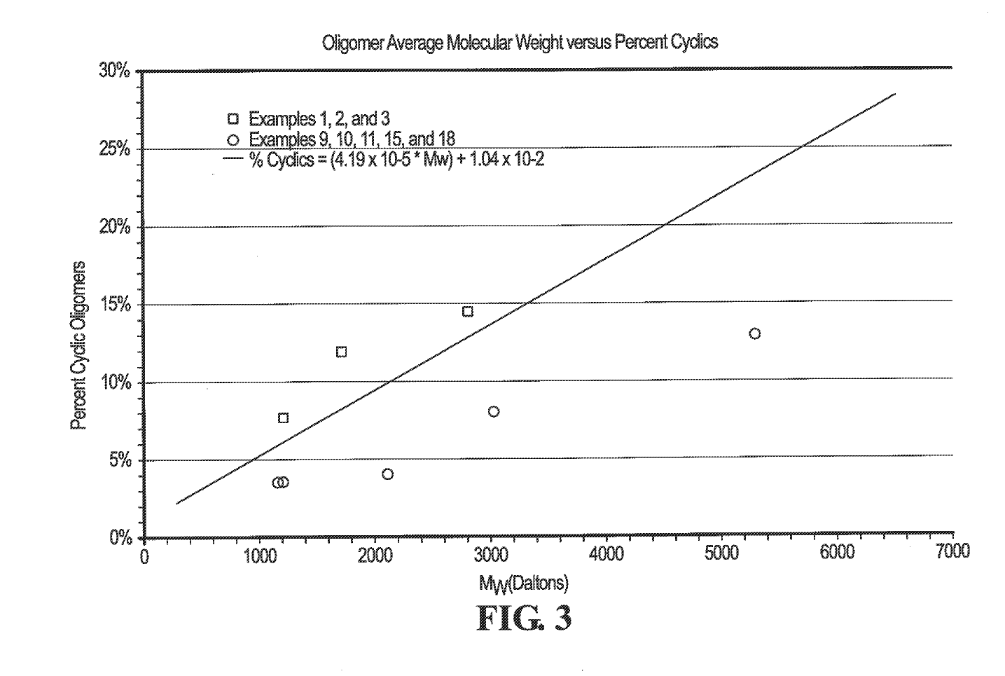

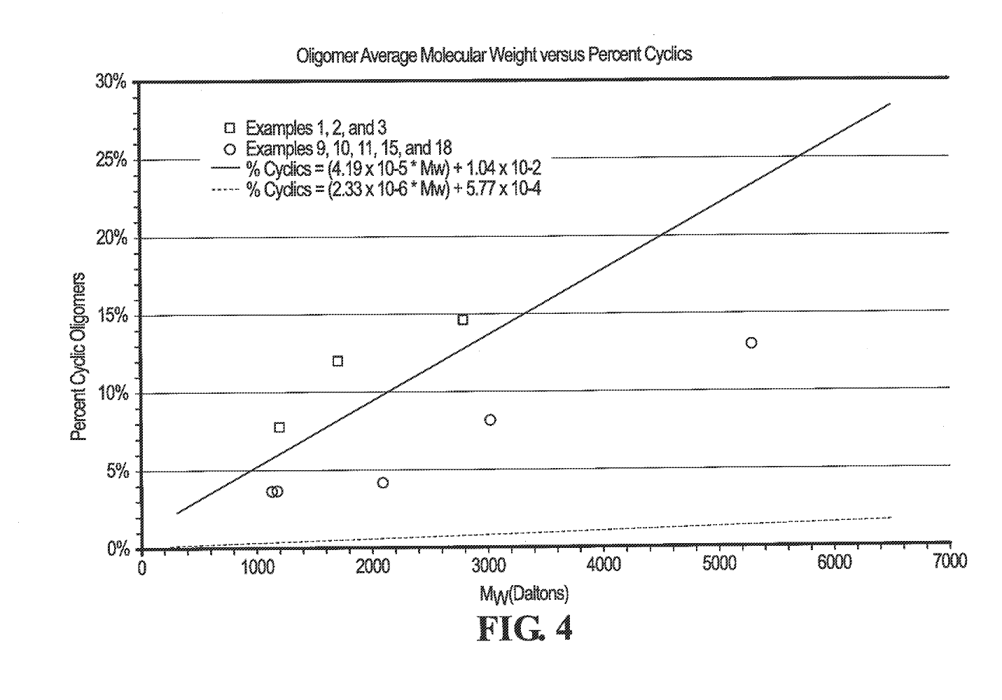

Other values and ranges for the % cyclic compounds in the composition based on the M_{w} of the oligomers of the composition are readily apparent from the present disclosure, e.g., as illustrated in FIGS. 3-4, to be discussed further in the Example section.

In another embodiment, the % cyclics in the oligomer composition can be correlated with the M_{w} of the composition, inclusive of residual monomer, and can be characterized by the equation:

% cyclics=approximately {(2.32×10⁻⁵*M_{w})+0.009]}.

In this equation, “approximately” means within +/−75%; alternatively, within +/−50%; or alternatively, within +/−25%. For instance, the % cyclics in the oligomer composition can fall in a range between (M_{w} is for the composition, inclusive of monomer):

0.5*{(2.32×10⁻⁵*M_{w})+0.009]} and 1.5*{(2.32×10⁻⁵*M_{w})+0.009]}.

In yet another embodiment, the % cyclics in the oligomer composition can be correlated with the M_{w} of the oligomers of the composition, exclusive of residual monomer, and can be characterized by the equation:

% cyclics=approximately {(2.33×10⁻⁵*M_{w})+0.0058]}.

In this equation, as noted above, “approximately” means within +/−75%; alternatively, within +/−50%; or alternatively, within +/−25%. As an example, the % cyclics of the oligomer composition can fall in a range between (M_{w} is for the oligomers of the composition, exclusive of monomer):

0.5*{(2.33×10⁻⁵*M_{w})+0.0058]} and 1.5*{(2.33×10⁻⁵*M_{w})+0.0058]}.

As one of skill in the art would recognize, treatment of disulfides with LiAlH₄ can reduce polysulfide linkages to mercaptans. For example, LiAlH₄ reduction of R—S—S—R can result in R—S—H as a product. In theory, it could be expected that linear oligomers and cyclic oligomers of a bis(beta-hydroxy)polysulfide would have the following structures, where q is greater than equal to 0, and x, R¹, R², R³, R⁴, R⁵, R⁶, R⁷, and R⁸ are as described herein:

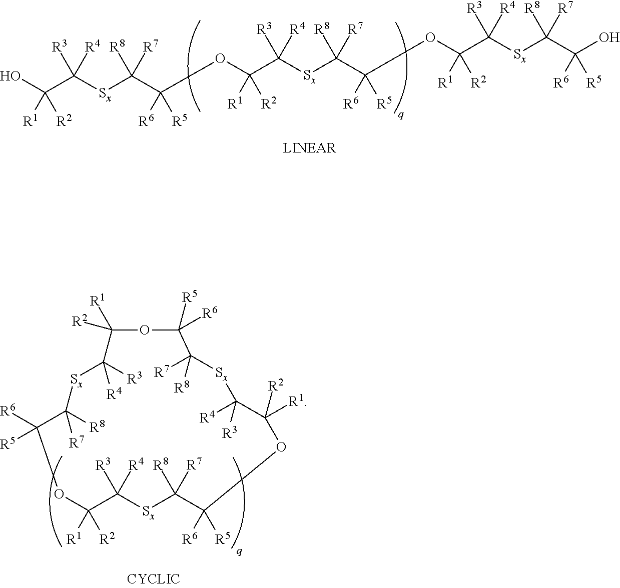

Accordingly, LiAlH₄ reduction of these theoretical linear and cyclic bis(beta-hydroxy)polysulfide oligomers should produce the following products:

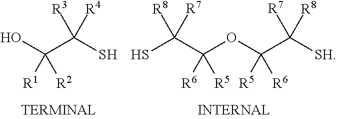

For dihydroxydiethyl disulfide, R¹, R², R³, R⁴, R⁵, R⁶, R⁷, and R⁸ are hydrogen, Therefore, a LiAlH₄ reduction of these theoretical linear and cyclic oligomers derived from dihydroxydiethyl disulfide should produce the following products:

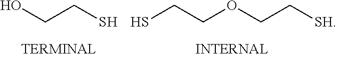

However, and unexpectedly, LiAlH₄ reduction of the linear and cyclic oligomers derived from dihydroxydiethyl disulfide can produce many other products in addition to the expected terminal and internal compounds illustrated above. GC-MS and MALDI-TOF MS (Matrix-assisted laser desorption/ionization—time of flight mass spectrometry) analysis of the products produced by the LiAlH₄ reduction of the linear and cyclic dihydroxydiethyl disulfide oligomers indicate that the linear and cyclic dihydroxydiethyl disulfide oligomers can comprise the following repeating units, amongst others, in a multitude of combinations:

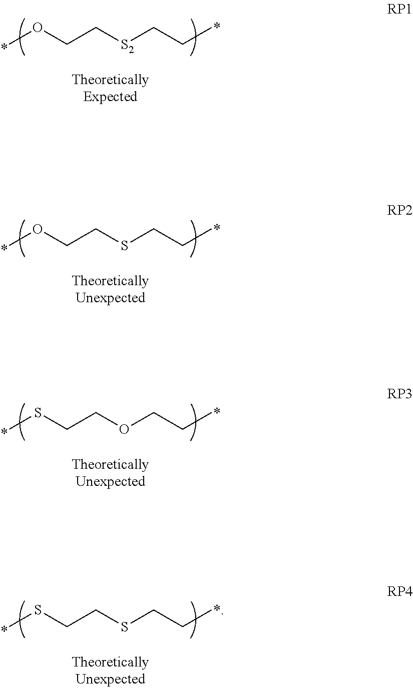

Theoretically unexpected units RP2 and RP3 can have a molecular weight of about 104 g/mol. Theoretically unexpected unit RP4 can have a molecular weight of about 120 g/mol. Based upon these units and not to be limited by theory, the LiAlH₄ reduced dihydroxydiethyl disulfide oligomer product could be expected to contain the materials having Structure R1, R2, and R3, among LiAlH₄ reduced dihydroxydiethyl disulfide oligomer products having other structures:

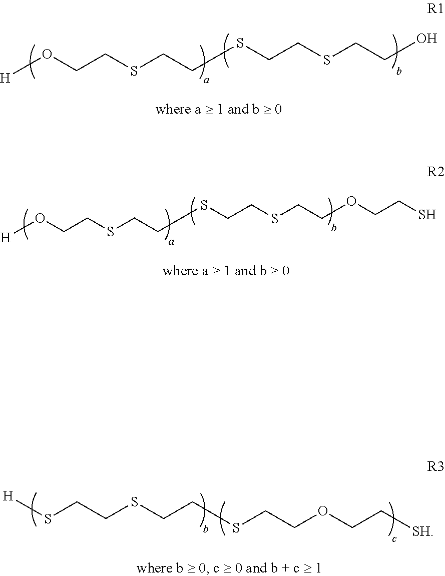

It should be noted that the LiAlH₄ reduced dihydroxydiethyl disulfide oligomer product Structures R1, R2, and R3 appear to designate a particular order for the units RP1, RP2, RP3, and/or RP4. This is not the intent of LiAlH₄ reduced dihydroxydiethyl disulfide oligomer product Structures R1, R2, and R3. The intent of the LiAlH₄ reduced dihydroxydiethyl disulfide oligomer product Structures R1, R2, and R3 is to show the compositional makeup of the LiAlH₄ reduced dihydroxydiethyl disulfide oligomer products R1, R2, and R3 in terms of the particular unit, and the number of each particular unit, present in the product. In fact, when RP2 and RP4 units are present in a particular LiAlH₄ reduced dihydroxydiethyl disulfide oligomer product having Structure R1 and/or R2 and a+b≧3, the RP2 and RP4 units can be arranged in any conceivable order wherein, when the LiAlH₄ reduced dihydroxydiethyl disulfide oligomer product can have Structure R1 and/or R2, then one terminus of R1 and/or R2 must be the repeating unit having Structure RP2. Additionally, when both RP3 and RP4 units are present in a LiAlH₄ reduced dihydroxydiethyl disulfide oligomer product having Structure R3 and b+c≧3, the RP3 and RP4 units can be arranged in any conceivable order.

In some aspects, the bis(beta-hydroxy)polysulfide may have Formula I. Accordingly, oligomers derived from bis(beta-hydroxy)polysulfides having Formula I can have the units RP11, RP12, RP13, and RP14 (among others), and the LiAlH₄ reduced oligomer products R11, R12, and R13, (among others):

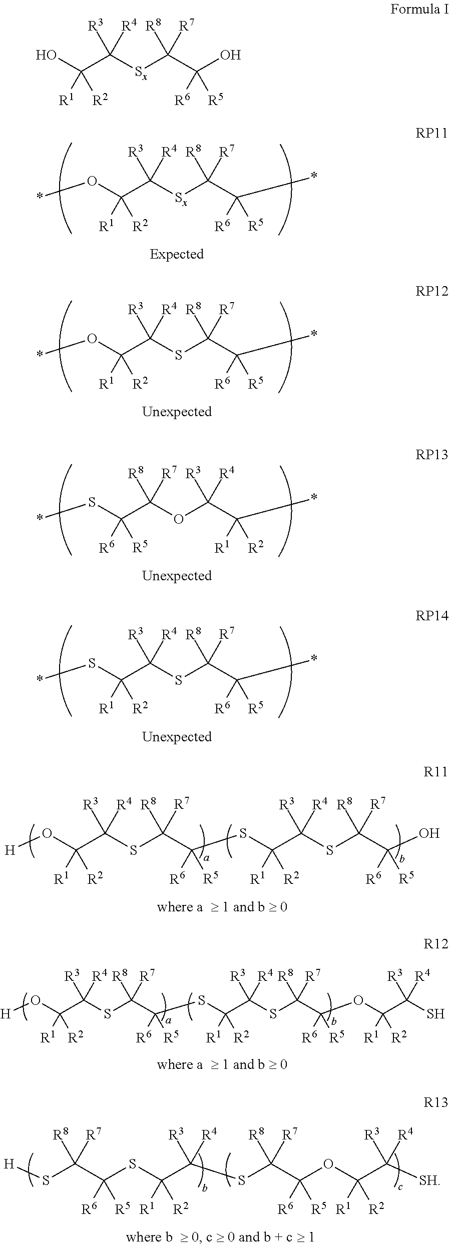

In others aspects, the bis(beta-hydroxy)polysulfide may have Formula II. In like manner, oligomers derived from bis(beta-hydroxy)polysulfides having Formula II can have the units RP21, RP22, RP23, and RP24 (among others), and the LiAlH₄ reduced oligomer products R21, R22, and R23, (among others):

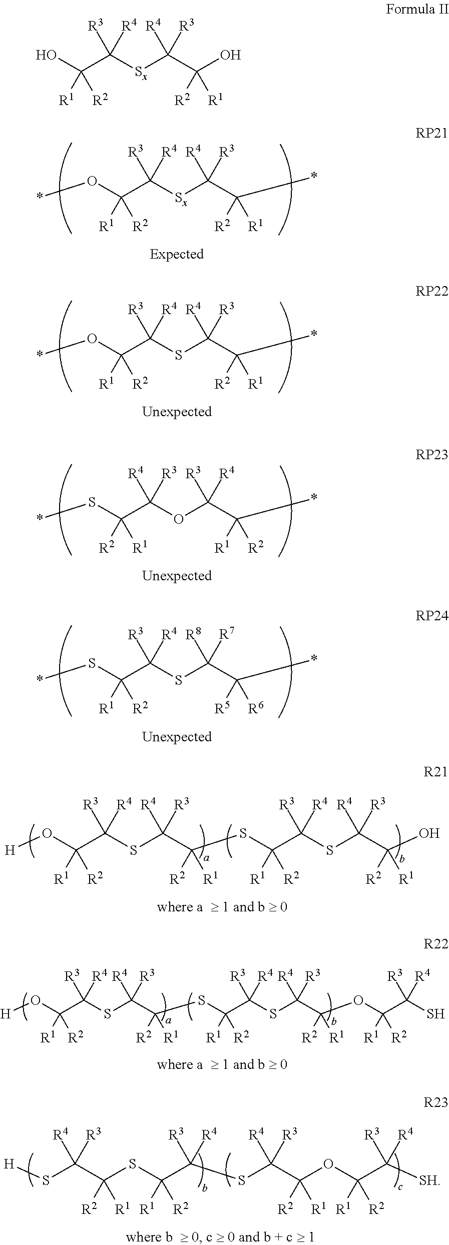

Moreover, in additional aspects, the bis(beta-hydroxy)polysulfide may have Formula III. Oligomers derived from such bis(beta-hydroxy)polysulfides having Formula III can have the units RP31, RP32, RP33, and RP34 (among others), and the LiAlH₄ reduced oligomer products R31, R32, and R33 (among others):

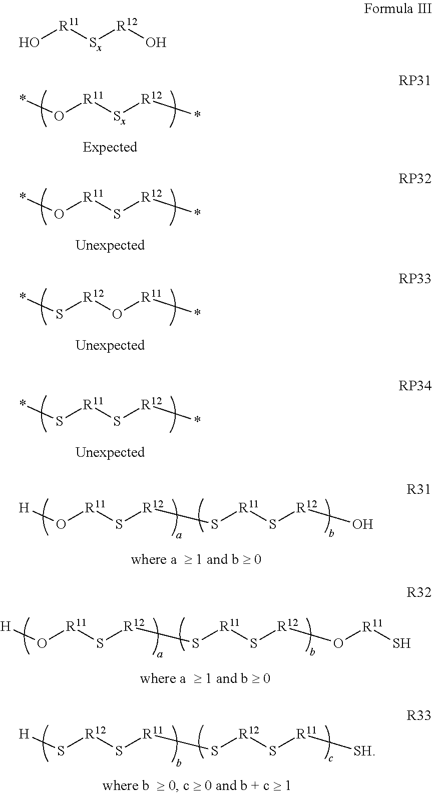

Moreover, in additional aspects, the bis(beta-hydroxy)polysulfide may have Formula IV. Oligomers derived from such bis(beta-hydroxy)polysulfides having Formula IV can have the units RP41, RP42, RP43, and RP44 (among others), and the LiAlH₄ reduced oligomer products R41, R42, and R43 (among others):

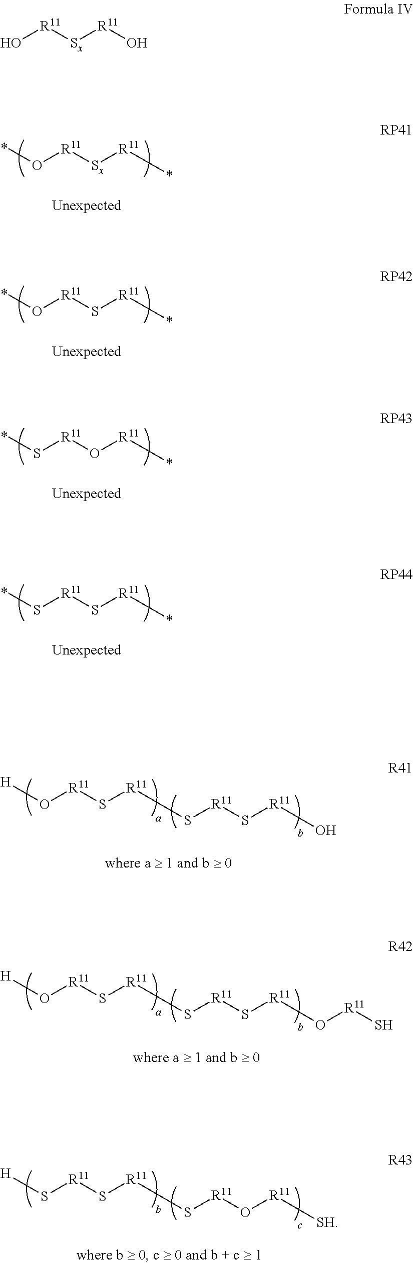

Similar to that of the LiAlH₄ reduced dihydroxydiethyl disulfide oligomer product Structures RP1, RP2, and RP3, it should be noted that LiAlH₄ reduced bis(beta-hydroxy)polysulfide oligomer product structures appear to designate a particular order for the units found in the LiAlH₄ reduced bis(beta-hydroxy)polysulfide oligomer product structures. This is not the intent of LiAlH₄ reduced bis(beta-hydroxy)polysulfide oligomer product structures. The intent of the LiAlH₄ reduced bis(beta-hydroxy)polysulfide oligomer product structures is to show the compositional makeup of the LiAlH₄ reduced bis(beta-hydroxy)polysulfide oligomer products in terms of the particular units, and the number of each particular unit, present in the LiAlH₄ reduced bis(beta-hydroxy)polysulfide oligomer product. For example, when RP12 and RP14 units are present in a particular LiAlH₄ reduced bis(beta-hydroxy)polysulfide oligomer product having Structure R11 and/or R12 and b+c≧3, the RP12 and RP14 units can be arranged in any conceivable order wherein, when the LiAlH₄ reduced bis(beta-hydroxy)polysulfide oligomer product can have Structure R11 and/or R12, then one terminus of R11 and/or R12 must be the unit having Structure RP12. Additionally, when both RP13 and RP14 units are present in a LiAlH₄ reduced bis(beta-hydroxy)polysulfide oligomer product having Structure R13 and b+c≧3, the RP13 and RP14 units can be arranged in any conceivable order. The LiAlH₄ reduced bis(beta-hydroxy)polysulfide oligomer products having structures RP21, RP22 and RP23, RP31, RP32 and RP23, and RP41, RP42 and RP43 have the same features as described herein for RP1, RP2, and RP3.

It has been discovered that the bis(beta-hydroxy)polysulfide oligomers described herein or produced by a process described herein can have a previously unreported ratio of the number of repeating units in the LiAlH₄ reduced bis(beta-hydroxy)polysulfide oligomer dimercaptan product having the maximum number of only RP3 units (alternatively, RP13 units; alternatively, RP23 units; alternatively, RP33 units; or alternatively, RP43 units), i.e., R3, R13, R23, R33, or R43 where b=0, to the number of repeating units in the LiAlH₄ reduced bis(beta-hydroxy)polysulfide oligomer dimercaptan product having the maximum number of only RP4 units (alternatively, R13 units; alternatively, R23 units; alternatively, R33 units; or alternatively, R43 units), i.e., R3, R13, R23, R33, or R43 where c=0. Generally, the LiAlH₄ reduced bis(beta-hydroxy)polysulfide oligomer dimercaptan product having Structure R3 (alternatively, Structure R13; alternatively, Structure R23; alternatively, Structure R33; or alternatively, Structure R43) having only RP3 units can have Structure R3 (alternatively, Structure R13; alternatively, Structure R23; alternatively, Structure R33; or alternatively, Structure R43) where b=0. Generally, the LiAlH₄ reduced bis(beta-hydroxy)polysulfide oligomer dimercaptan product having only RP3 units (alternatively, RP13 units; alternatively, RP23 units; alternatively, RP33 units; or alternatively, RP43 units) can have Structure R3 (alternatively, Structure R13; alternatively, Structure R23; alternatively, Structure R33; or alternatively, Structure R43) where c=0.

The LiAlH₄ reduced bis(beta-hydroxy)polysulfide oligomer dimercaptan product having Structure R3 having only RP3 units has Structure R4, while the LiAlH₄ reduced bis(beta-hydroxy)polysulfide oligomer dimercaptan product having Structure R3 having only RP4 units has Structure R5. The LiAlH₄ reduced bis(beta-hydroxy)polysulfide oligomer dimercaptan product having Structure R13 having only RP13 units has Structure R14, while the LiAlH₄ reduced bis(beta-hydroxy)polysulfide oligomer dimercaptan product having Structure R13 having only RP14 units has Structure R15. The LiAlH₄ reduced bis(beta-hydroxy)polysulfide oligomer dimercaptan product having Structure R23 having only RP23 units has Structure R24, while the LiAlH₄ reduced bis(beta-hydroxy)polysulfide oligomer dimercaptan product having Structure R23 having only RP24 units has Structure R25. The LiAlH₄ reduced bis(beta-hydroxy)polysulfide oligomer dimercaptan product having Structure R33 having only RP33 units has Structure R34, while the LiAlH₄ reduced bis(beta-hydroxy)polysulfide oligomer dimercaptan product having Structure R33 having only RP34 units has Structure R35. The LiAlH₄ reduced bis(beta-hydroxy)polysulfide oligomer dimercaptan product having Structure R43 having only RP43 units has Structure R44 while the LiAlH₄ reduced bis(beta-hydroxy)polysulfide oligomer dimercaptan product having Structure R43 having only RP44 units has Structure R45:

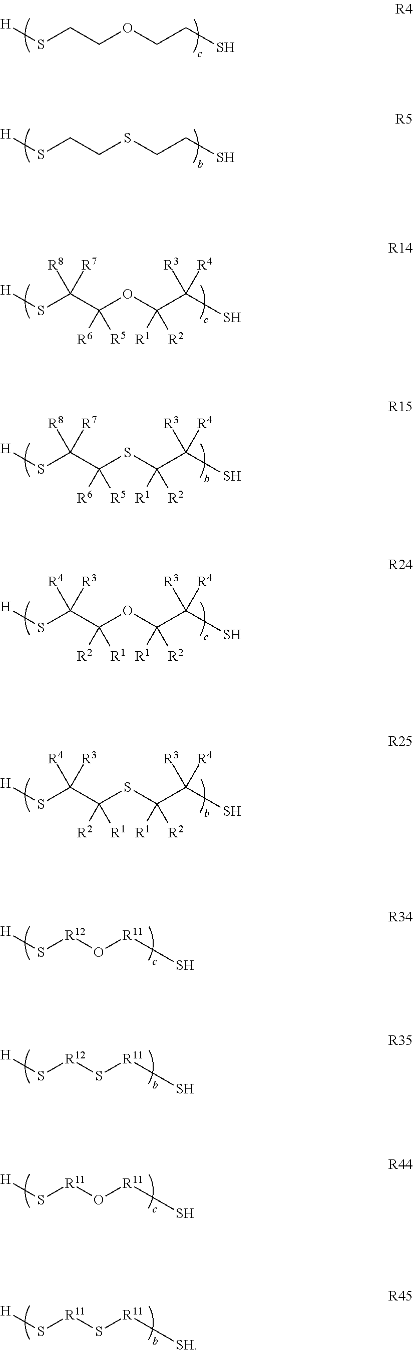

In an aspect of the present invention, the maximum ratio of the largest c of a LiAlH₄ reduced bis(beta-hydroxy)polysulfide oligomer dimercaptan product having Structure R4 (alternatively, Structure R14; alternatively, Structure 24; alternatively, Structure 34; or alternatively, Structure 44) to the largest b of a LiAlH₄ reduced bis(beta-hydroxy)polysulfide oligomer dimercaptan product having Structure R5 (alternatively, Structure R15; alternatively, Structure 25; alternatively, Structure 35; or alternatively, Structure 45) can be less than or equal to 1.1; alternatively, less than or equal to 1.0; alternatively, less than or equal to 0.9; alternatively, less than or equal to 0.8; alternatively, less than or equal to 0.7; or alternatively, less than or equal to 0.6. In an embodiment, the minimum ratio of the largest c of a LiAlH₄ reduced bis(beta-hydroxy)polysulfide oligomer dimercaptan product having Structure R4 (alternatively, Structure R14; alternatively, Structure 24; alternatively, Structure 34; or alternatively, Structure 44) to the largest b of a LiAlH₄ reduced bis(beta-hydroxy)polysulfide oligomer dimercaptan product having Structure R5 (alternatively, Structure R15; alternatively, Structure 25; alternatively, Structure 35; or alternatively, Structure 45) can be greater than or equal to 0.025; alternatively, greater than or equal to 0.05; alternatively, greater than or equal to 0.075; or alternatively, greater than or equal to 0.1. In embodiment, the ratio of the largest c of a LiAlH₄ reduced bis(beta-hydroxy)polysulfide oligomer dimercaptan product having Structure R4 (alternatively, Structure R14; alternatively, Structure 24; alternatively, Structure 34; or alternatively, Structure 44) to the largest b of a LiAlH₄ reduced bis(beta-hydroxy)polysulfide oligomer dimercaptan product having Structure R5 (alternatively, Structure R15; alternatively, Structure 25; alternatively, Structure 35; or alternatively, Structure 45) can range from any minimum ratio value described herein to any maximum ratio value described herein. In some non-limiting embodiments, the ratio of the largest c of a LiAlH₄ reduced bis(beta-hydroxy)polysulfide oligomer dimercaptan product having Structure R4 (alternatively, Structure R14; alternatively, Structure 24; alternatively, Structure 34; or alternatively, Structure 44) to the largest b of a LiAlH₄ reduced bis(beta-hydroxy)polysulfide oligomer dimercaptan product having Structure R5 (alternatively, Structure R15; alternatively, Structure 25; alternatively, Structure 35; or alternatively, Structure 45) can range from 0.025 to 1.1; alternatively, from 0.05 to 1.1; alternatively, 0.05 to 1.0; or alternatively, from 0.075 to 0.9. Other values and ranges for the ratio of the largest c of a LiAlH₄ reduced bis(beta-hydroxy)polysulfide oligomer dimercaptan product having Structure R4 (alternatively, Structure R14; alternatively, Structure 24; alternatively, Structure 34; or alternatively, Structure 44) to the largest b of a LiAlH₄ reduced bis(beta-hydroxy)polysulfide oligomer dimercaptan product having Structure R5 (alternatively, Structure R15; alternatively, Structure 25; alternatively, Structure 35; or alternatively, Structure 45) are readily apparent from the present disclosure.

### EXAMPLES

The invention is further illustrated by the following examples, which are not to be construed in any way as imposing limitations to the scope of this invention. Various other aspects, embodiments, modifications, and equivalents thereof which, after reading the description herein, may suggest themselves to one of ordinary skill in the art without departing from the spirit of the present invention or the scope of the appended claims.

A preparative HPLC procedure involved dissolving the sample (approximately 6 mg/ml concentration) in THF and injecting 20 μL to 500 μL onto semi-preparative YMC Pack Diol-120-NP column (250 mm×20 mm I.D., S-5 micron particle size) utilizing hexane/THF (72/28 v/v) ratio as the eluting phase at ambient temperature. The flow rate was 7 mL/min and the detection by UV at 254 nm. Cyclic oligomeric compounds typically eluted in less than 20 min, while non-cyclic oligomers took longer to elute.

An analytical HPLC procedure involved dissolving the sample (approximately 6 mg/ml concentration) in THF and injecting 20 μL onto a YMC diol column (250×4.6 mm I.D., S-5 micron particle size) utilizing hexane/THF (72/28 v/v) ratio as the eluting phase at ambient temperature. The flow rate was 2 mL/min and the detection by UV at 254 nm. Cyclic oligomeric compounds typically eluted in less than 4 min, while non-cyclic oligomers took longer to elute.

GPC was carried out utilizing four PLGel Minimix D 5 micron (250 mm by 4.6 mm) GPC columns. The flow rate was 0.3 mL/min and the detection by UV at 254 nm. M_{w} and Mₙ were calculated by Empower Waters software by standard M_{w} and Mₙ calculations. Polystyrene molecular weight standards were utilized to determine the various molecular weights (Mₙ, M_{w}, Mₚ, etc.). The specific molecular weight standards were from Polymer Labs (Polystyrene, Mₙ=1200, 3.2 mg in 3.5 gm THF(Red), Mₙ=580, 8210, 3.2 and 2.4 mg in 3.5 gm THF(Yellow), Mₙ=162, 3370, 3.2 and 2.4 mg in 3 gm THF(Green). Approximate 30 mg samples were dissolved in about 4 grams of THF.

C-13 NMR and H-1 NMR spectra were obtained on a Varian Mercury Plus 300 NMR spectrometer, operating at 300.1 MHz for H-1, and at 75.5 MHz for C-13. Samples were analyzed at 30% concentration in CDCl₃ or D₆C═O as a lock solvent. Tetramethylsilane (TMS) was used as an internal chemical shift reference (0.0 ppm).

Samples analyzed by the MALDI-TOF technique were analyzed using an Applied Biosystems 4700 Proteomics Analyzer MALDI-TOF/TOF MS (Applied Biosystems, Framingham, Mass.) equipped with a 355-nm Nd:YAG laser. All spectra were obtained in the positive ion mode using an accelerating voltage of 8 kV for the first source and 15 kV for the second source and a laser intensity of approximately 10% greater than threshold. The grid voltage, guide wire voltage, and delay time were optimized for each spectrum to achieve the best signal-to-noise ratio. For MS/MS spectra, the collision energy is defined by the potential difference between the source acceleration voltage and the floating collision cell; in our experiments, this voltage difference was set to 1 kV. Air was used as a collision gas at pressures of 1.5×10⁻⁶ and 5×10⁻⁶ Torr. All spectra were acquired in the reflectron mode with a mass resolution greater than 3000 fwhm; isotopic resolution was observed throughout the entire mass range detected. External mass calibration was performed using protein standards from a Sequazyme Peptide Mass Standard Kit (Applied Biosystems) and a three-point calibration method using Angiotensin I (m=1296.69 Da), ACTH (clip 1-17) (m=2093.09 Da), and ACTH (clip 18-39) (m=2465.20 Da). Internal mass calibration was subsequently performed using a PEG standard (Mₙ=2000; Polymer Source, Inc.) to yield monoisotopic masses exhibiting a mass accuracy better than Δm=±0.05 Da. The instrument was calibrated before every measurement to ensure constant experimental conditions. MALDI samples were prepared using dithranol (Aldrich) as a matrix and sodium trifluoroacetate (NaTFA, Aldrich) as the cationizing agent. Samples were prepared by the dried-droplet method with weight (mg) ratios of 50:10:1 (dithranol:oligomer:NaTFA) in tetrahydrofuran (THF) or dichloromethane as the solvent. After vortexing the mixture for 30 sec, 1 μL of the mixture was pipetted onto the MALDI sample plate and allowed to air dry at room temperature. MS and MS/MS data were processed using the Data Explorer 4.9 software (Applied Biosystems).

### Comparative Example 1

### Oligomerization of Dihydroxydiethyl Disulfide Using the Process Described in Bertozzi

Comparative Example 1 employed a procedure similar to that described in a portion of Example 1 of U.S. Pat. No. 4,124,645 to Bertozzi, the disclosure of which is incorporated herein by reference in its entirety.

To a 3-necked round-bottomed flask equipped with a Dean-Stark trap (with the trap filled with 50 mL of benzene), 154.1 g of dihydroxydiethyl disulfide, 50 mL of benzene (100 mL total—50 mL in the round-bottomed flask and 50 mL in the Dean-Stark trap), and 12 g of p-toluene sulfonic acid were charged. While stirring, the flask contents were refluxed for 23 hours at a temperature in the 84-86° C. range. Over this time period, approximately 16 mL of water were collected.

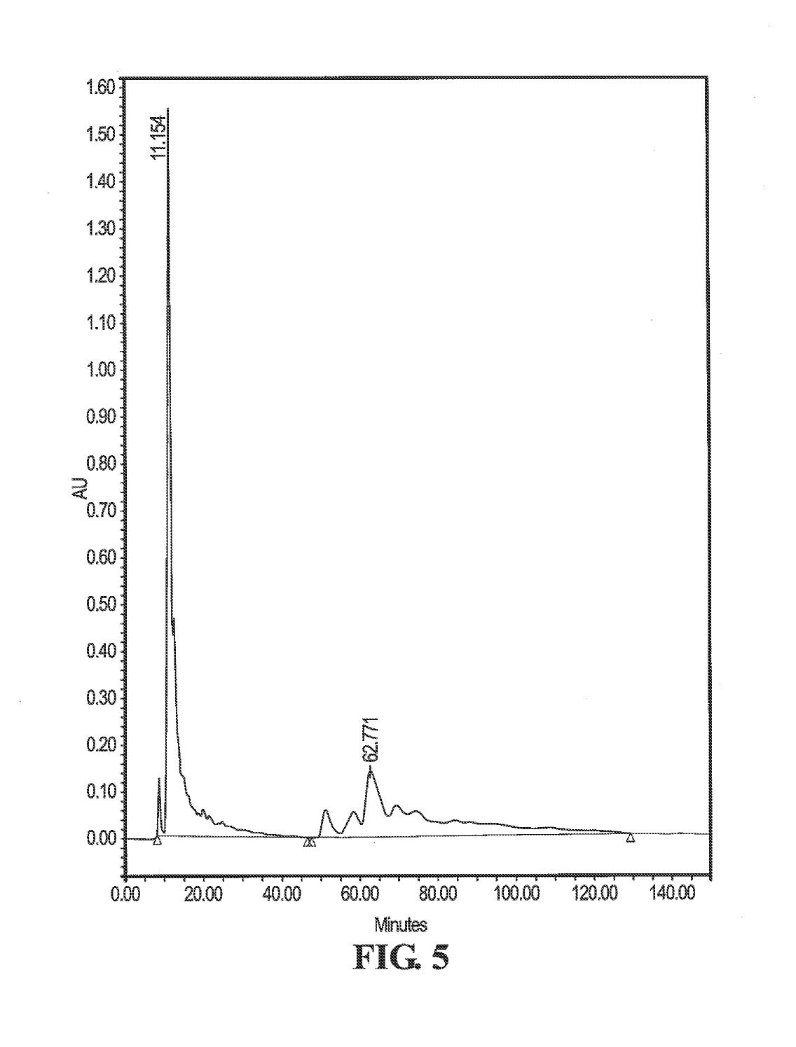

The round-bottomed flask contents were cooled to room temperature. Ammonia was then bubbled through the round-bottomed flask solution for 10 minutes. The resulting solution was then filtered by vacuum filtration through a celite filtercake. The filtered liquid product was poured into a Rotovap flask containing a small amount of THF used to wash the filter flask. The solvents were removed by pulling a vacuum at 80° C. for 1 hour. The resulting oligomerized product composition of Example 1 was analyzed using HPLC with the results illustrated in FIG. 5, and summarized in Table I. Based on area percentage, 54.8% of the oligomerized product composition of Example 1 was cyclic oligomeric compounds. The HPLC data of FIG. 5 and Table I are no longer relied upon. Applicants determined that the presence of a stabilizer in the HPLC solvent led to an erroneous determination of the amount of cyclic oligomeric compounds. Additionally, the HPLC data of FIG. 5 and Table I used the preparative HPLC method and column and, consequently, this data may not correlate with data in Table V, determined using the analytical HPLC method and column.

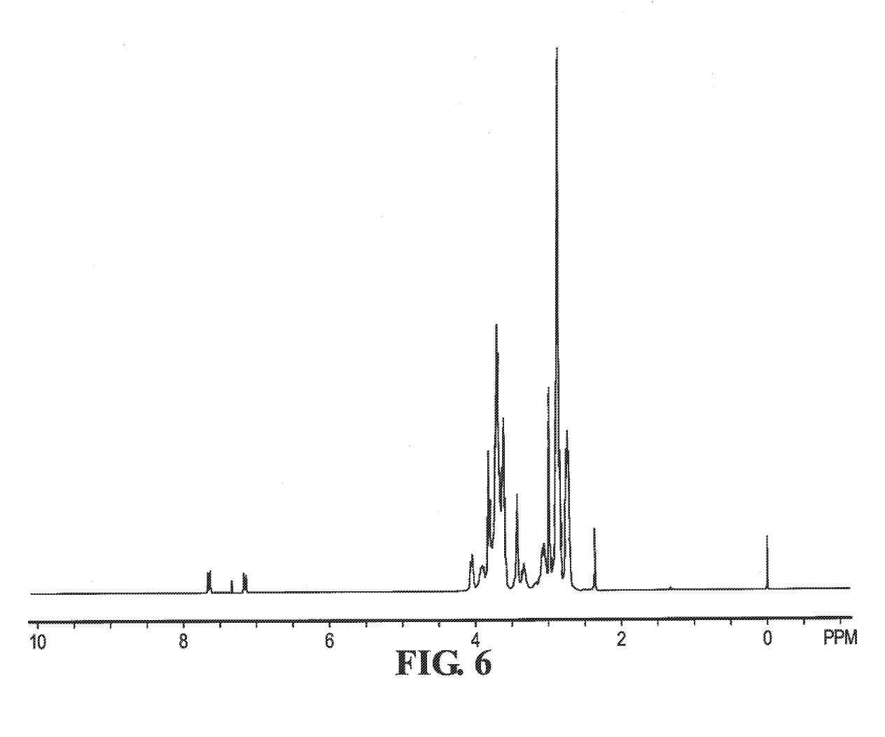

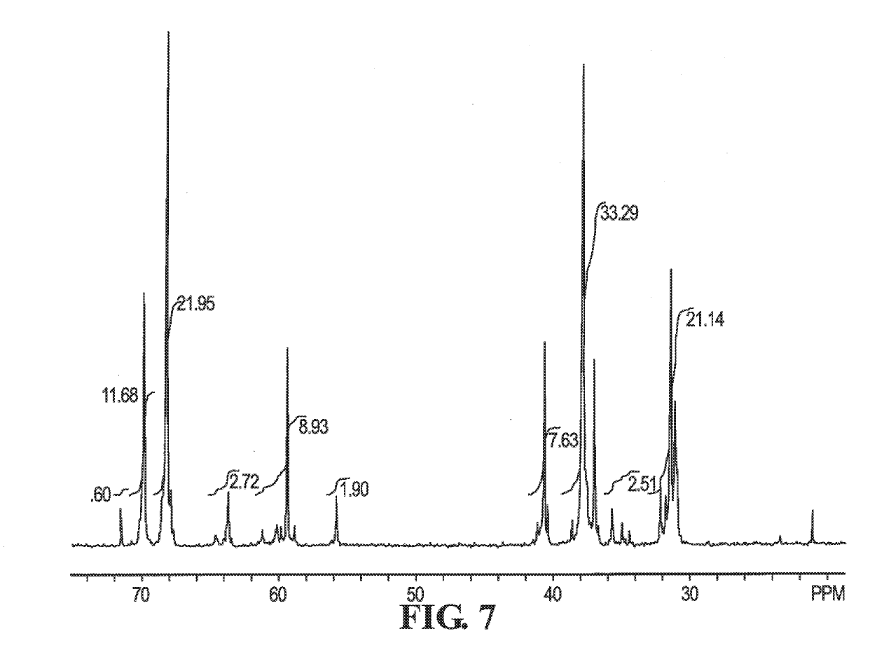

FIG. 6 and FIG. 7 are the H-1 NMR spectrum and the C-13 NMR spectrum, respectively, for the oligomerized product composition of Example 1. A summary of calculated values from the C-13 spectrum is provided in Table II. The calculated values in Table II are no longer relied upon. Applicants believe that the assumptions regarding the expected or theoretical oligomer repeat unit used to generate the calculated values are likely incorrect and led to an inaccurate determination of the calculated values in Table II.

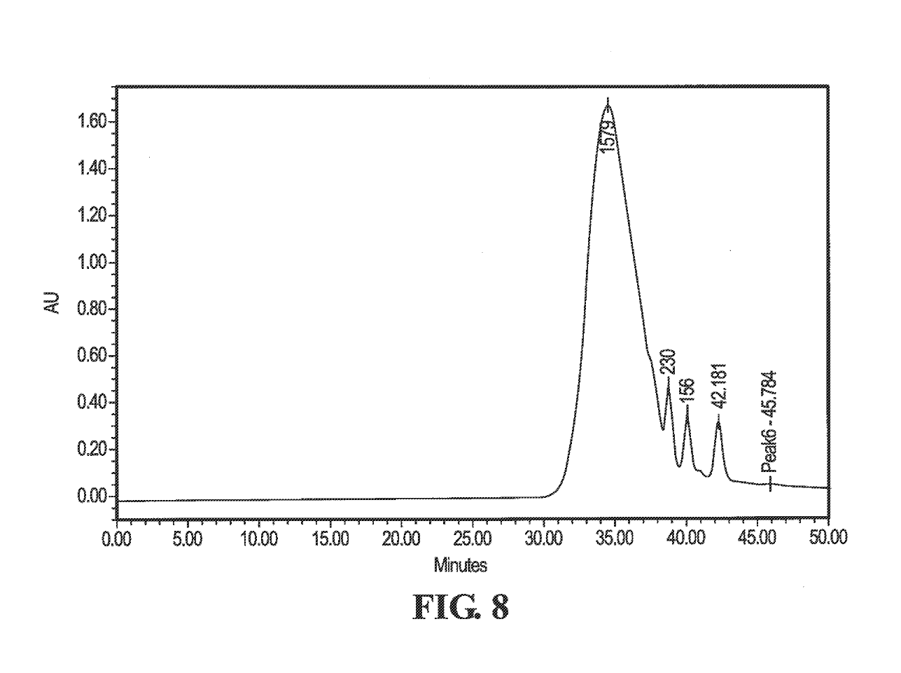

FIG. 8 is a GPC plot of the molecular weight distribution of the oligomerized product composition of Example 1. The Mₙ of the oligomers of the oligomerized product composition of Example 1, excluding monomer, was 1017.

TABLE I
HPLC Analysis of Oligomerized Product Composition of Example 1.

| Retention Time (min) | Product Type | Area Percentage |
|---|---|---|
| 11.15 | Cyclics | 54.8 |
| 62.77 | Non-Cyclics | 45.2 |

### Comparative Example 2

### Oligomerization of Dihydroxydiethyl Disulfide Using the Process Described in Bertozzi

Comparative Example 2 employed a procedure similar to that of Comparative Example 1, the difference being that the total amount of benzene used was 87 mL.

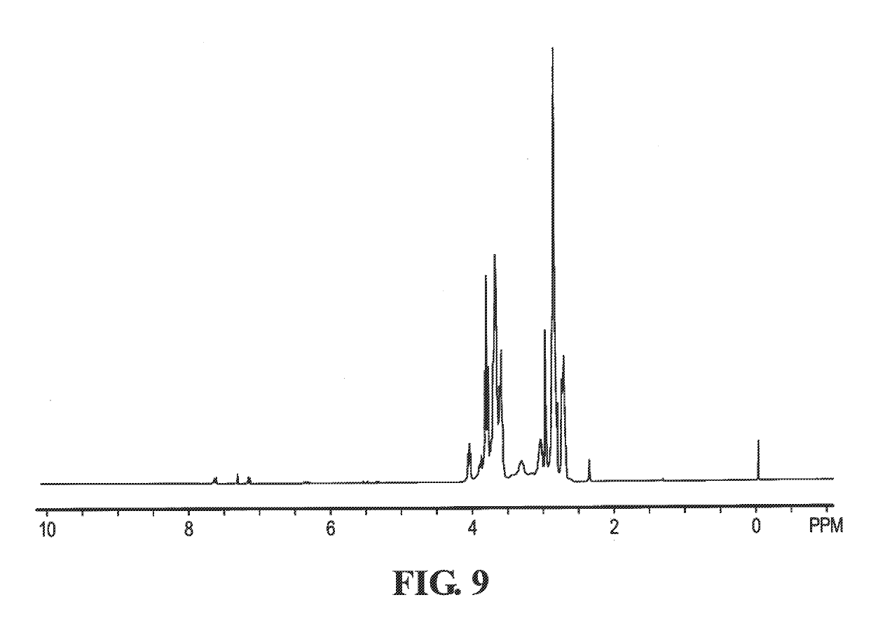

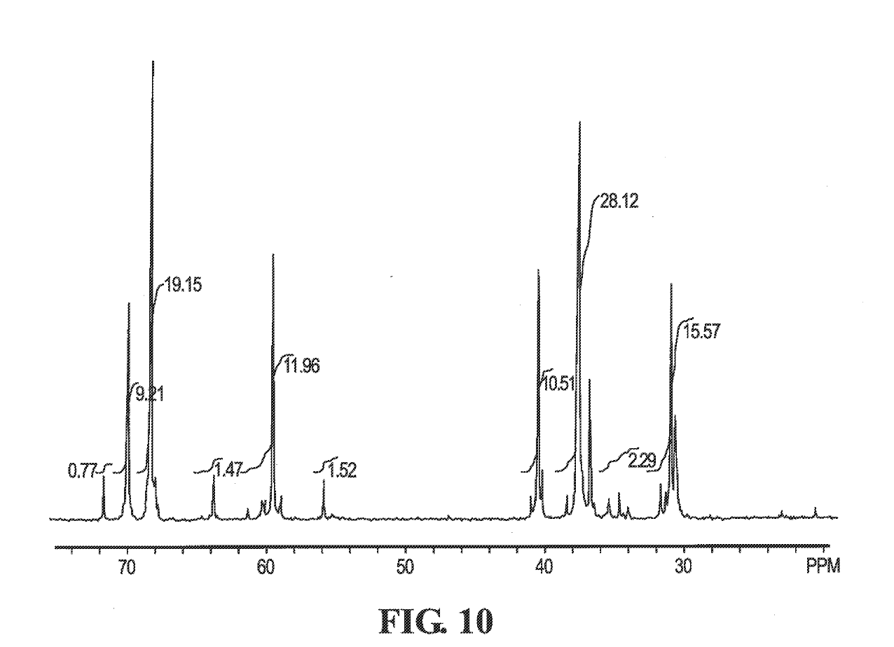

FIG. 9 and FIG. 10 are the H-1 NMR spectrum and the C-13 NMR spectrum, respectively, for the oligomerized product composition of Example 2. A summary of calculated values from the C-13 spectrum is provided in Table II. The calculated values in Table II are no longer relied upon. Applicants believe that the assumptions regarding the expected or theoretical oligomer repeat unit used to generate the calculated values are likely incorrect and led to an inaccurate determination of the calculated values in Table II.

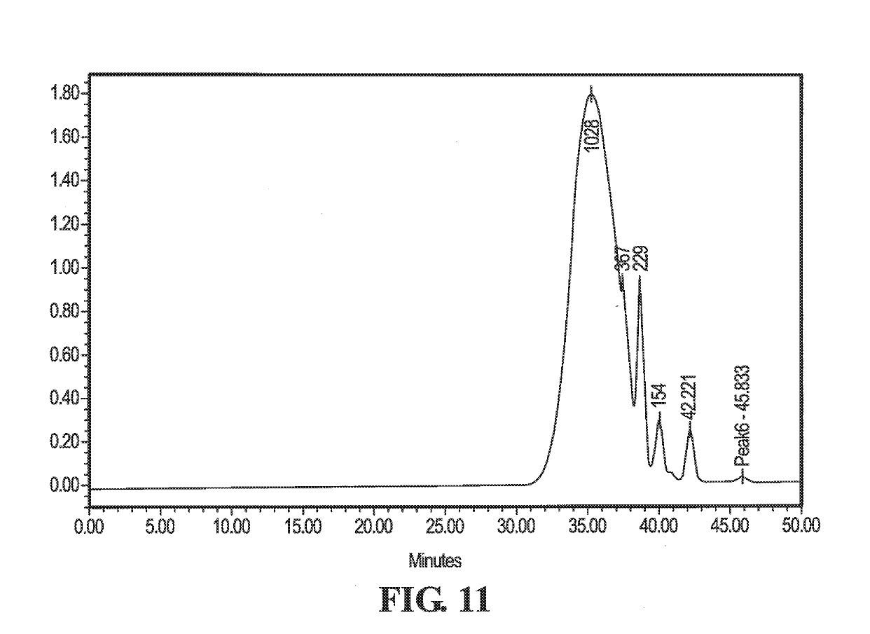

FIG. 11 is a GPC plot of the molecular weight distribution of the oligomerized product composition of Example 2. The Mₙ of the oligomers of the oligomerized product composition of Example 2, excluding monomer, was 852.

TABLE II
Calculated Values from C-13 Spectra of Examples 1-2

| | | DiHEDS + DiHETS | End | | Cyclic/ |
|---|---|---|---|---|---|
| | Repeat | +S4 and above | Groups | Mono S | Dimer |
| Example | Units | (mole %) | (mole %) | (mole %) | (mole %) |
| 1 | 8.0 | 59.9 | 14.2 | 25.2 | 0.6 |
| 2 | 5.5 | 55.8 | 22.2 | 21.3 | 0.2 |

Notes on Table II:
DiHEDS = dihydroxydiethyl disulfide
DiHETS = dihydroxydiethyl trisulfide

### Comparative Example 3

### Oligomerization of Dihydroxydiethyl Disulfide Using the Process Described in Bertozzi

Comparative Example 3 employed a procedure similar to that of Comparative Example 1, the major differences being that the total amount of benzene used was 65 mL, and the flask contents were refluxed for 24 hours at a temperature in the 84-86° C. range.

### Examples 4-8

### Oligomerization of Dihydroxydiethyl Disulfide Using a Non-Solvent Process

### Example 4

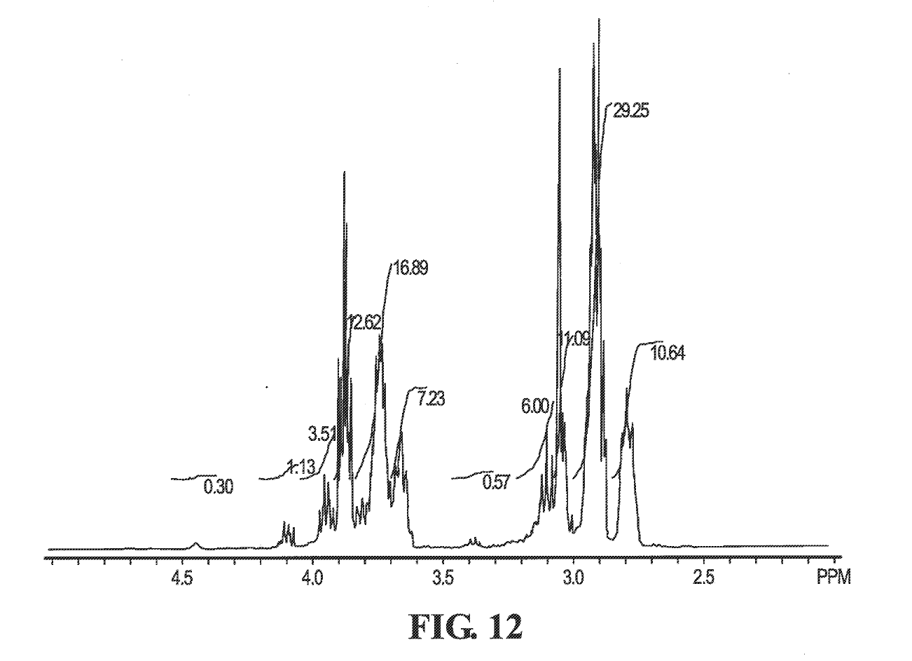

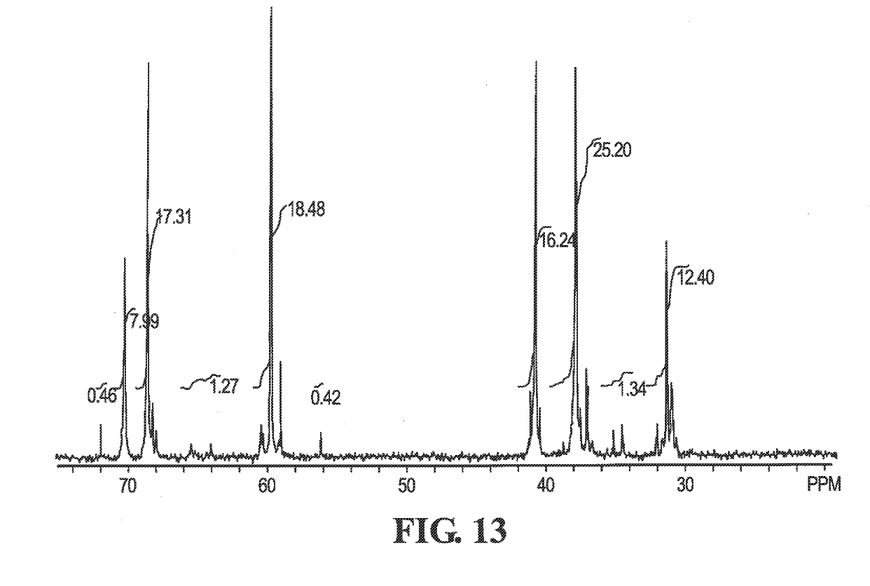

A 2000 mL, 3-necked round-bottomed flask was equipped with a vacuum pump with an intervening dry ice trap, a mechanical stirrer, and a nitrogen purge line. To the round-bottomed flask was charged 150.4 g of dihydroxydiethyl disulfide and 0.43 g of 70% methane sulfonic acid in Example 4. While stirring, the pressure in the flask was reduced to about 10 Torr and the temperature was increased to the 140-141° C. range. These conditions were maintained for a time period of about 2 hours, at which time a sample of the round-bottomed flask was removed for analysis. FIG. 12 and FIG. 13 represent the H-1 NMR spectrum and the C-13 NMR spectrum, respectively, for the 2 hour sample of the oligomerized product composition of Example 4.

### Example 5

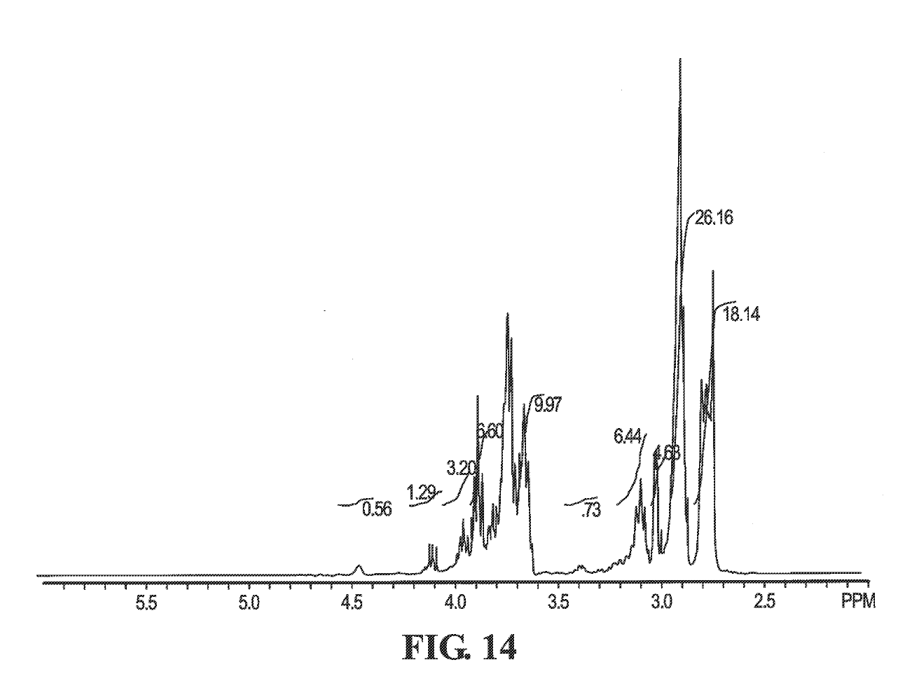

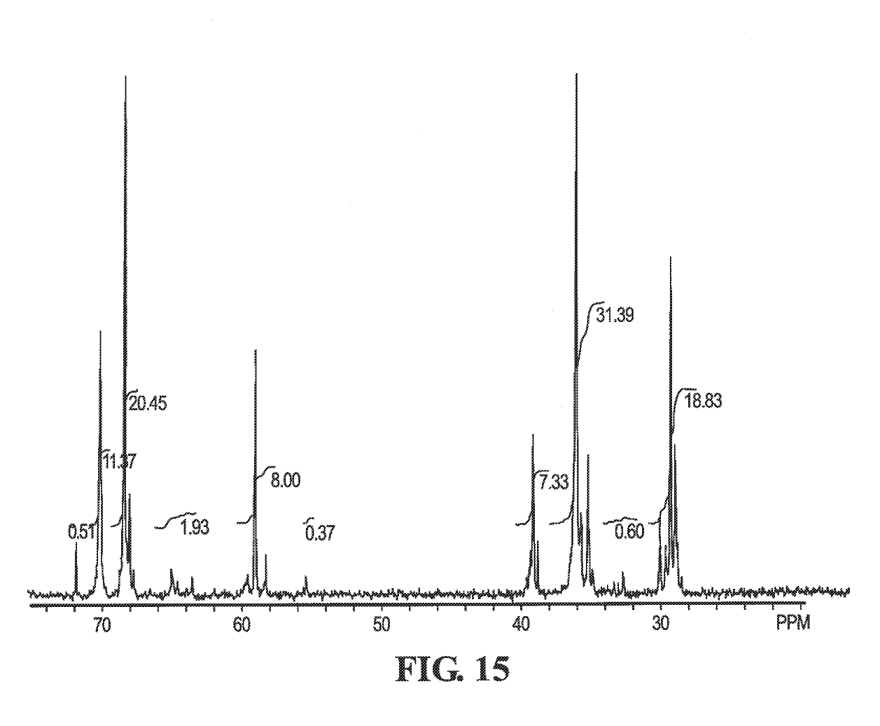

To the round-bottomed flask was charged 800 g of dihydroxydiethyl disulfide and 1.81 g of 70% methane sulfonic acid in Example 5. While stirring, the pressure in the flask was reduced to about 10 Torr and the temperature was increased to the 138-140° C. range. These conditions were maintained for a time period of about 4 hours, at which time a sample of the round-bottomed flask was removed for analysis. FIG. 14 and FIG. 15 represent the H-1 NMR spectrum and the C-13 NMR spectrum, respectively, for the 4 hour sample of the oligomerized product composition of Example 5.

### Example 6

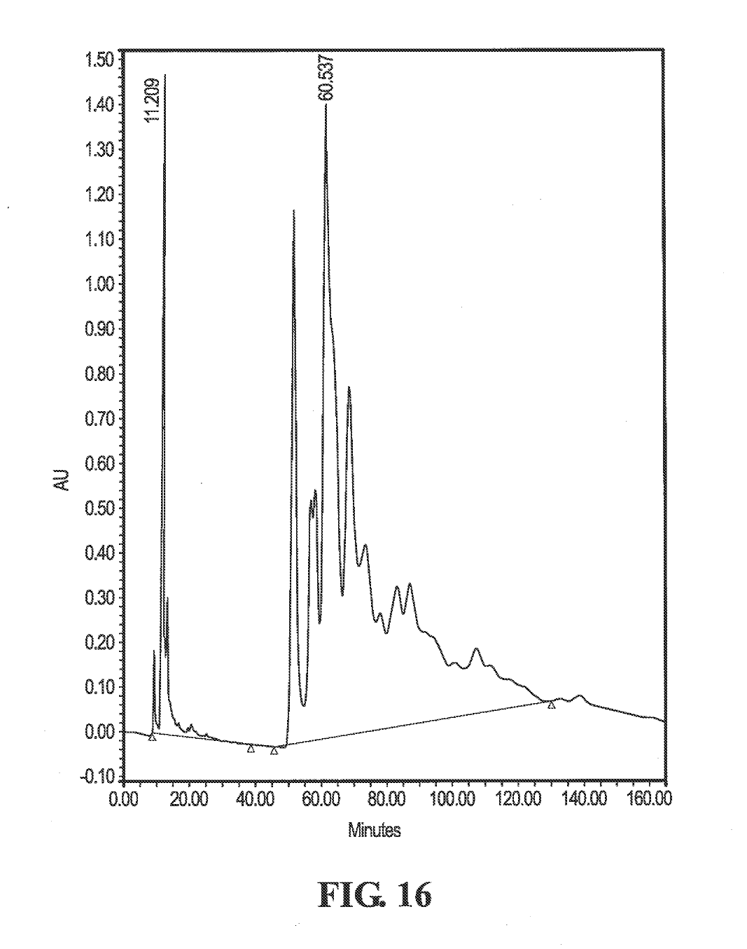

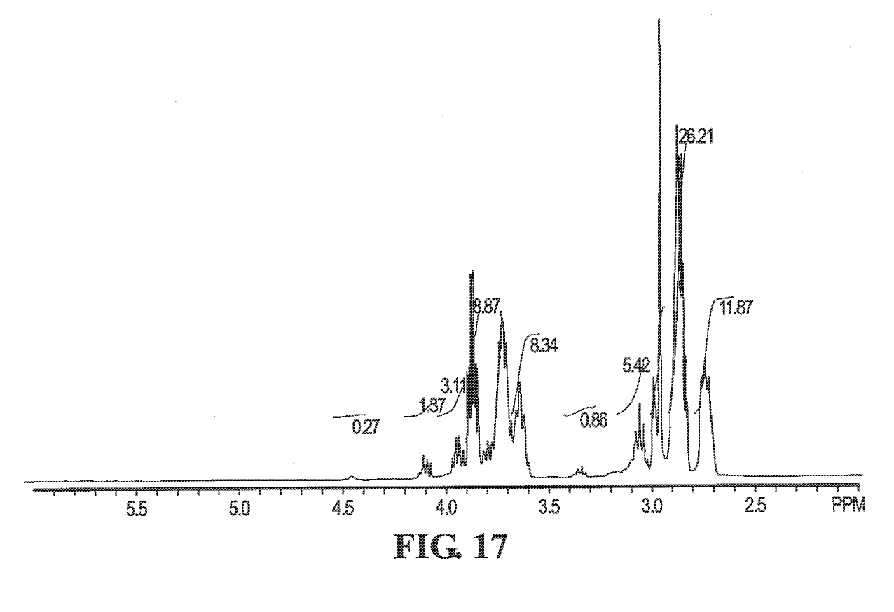

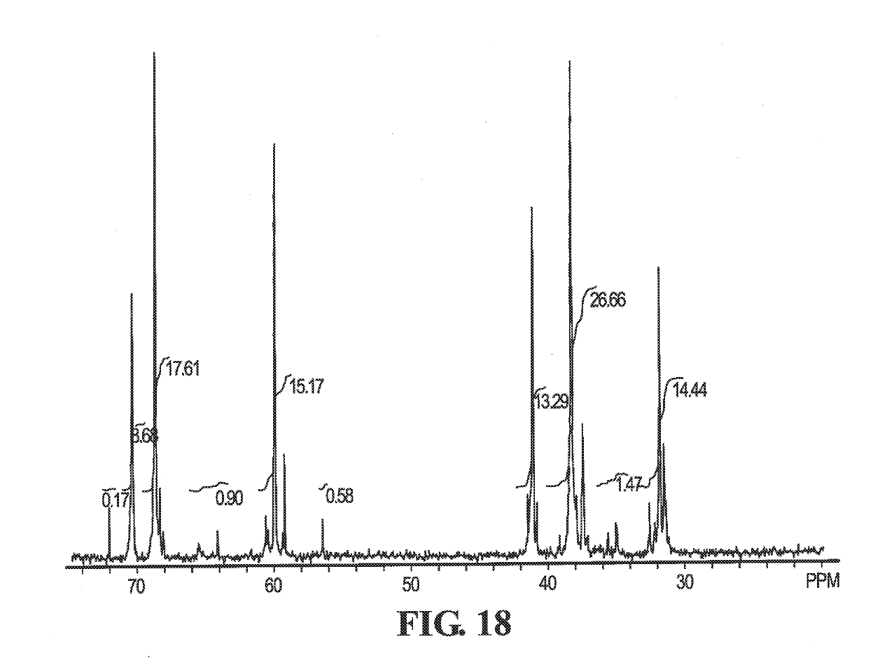

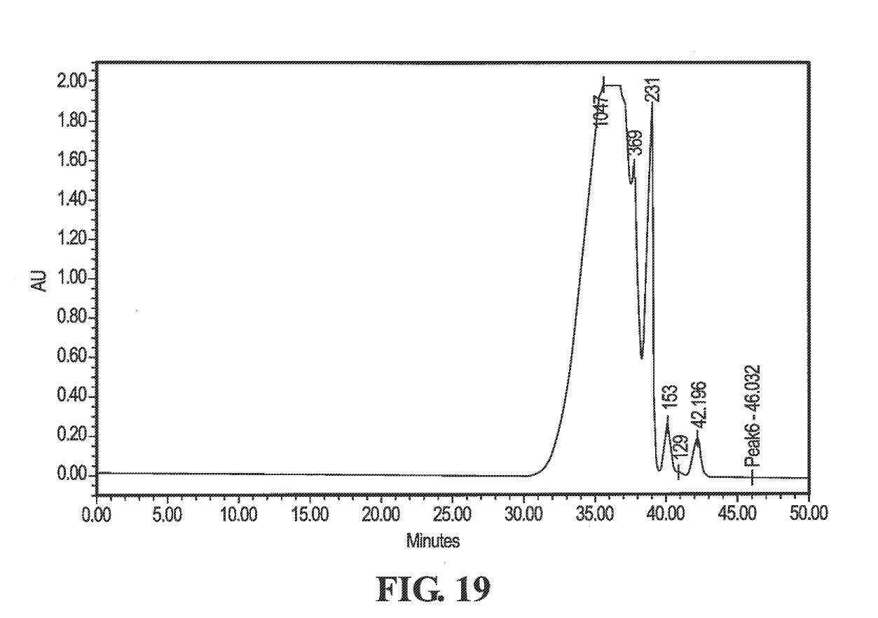

To the round-bottomed flask were charged 800 g of dihydroxydiethyl disulfide and 2.25 g of 70% methane sulfonic acid in Example 6. While stirring, the pressure in the flask was reduced to about 10 Torr and the temperature was increased to approximately 139° C. These conditions were maintained for a time period of about 2 hours, at which time a sample of the round-bottomed flask was removed for analysis. The oligomerized product composition of Example 6 was analyzed using HPLC with the results illustrated in FIG. 12, and summarized in Table III. Based on area percentage, 6.2% of the composition was cyclic oligomeric compounds. The HPLC data of FIG. 16 and Table III are no longer relied upon. Applicants believe that a stabilizer may have been present in the HPLC solvent. Additionally, the HPLC data of FIG. 16 and Table III used the preparative HPLC method and column and, consequently, this data may not correlate with data in Table V, determined using the analytical HPLC method and column. FIG. 17 and FIG. 18 are the H-1 NMR spectrum and the C-13 NMR spectrum, respectively, for the oligomerized product composition of Example 6. FIG. 19 is a GPC plot of the molecular weight distribution of the oligomerized product composition of Example 6. The Mₙ of the oligomers of the oligomerized product composition of Example 6, excluding monomer, was 740.

### Example 7

To the round-bottomed flask was charged 229.2 g of dihydroxydiethyl disulfide and 0.430 g of 70% methane sulfonic acid in Example 7. While stirring, the pressure in the flask was reduced to about 10 Torr and the temperature was increased to approximately 140° C. These conditions were maintained for a time period of about 4 hours, at which time a sample of the round-bottomed flask was removed for analysis.

### Example 8

To the round-bottomed flask were charged 800 g of dihydroxydiethyl disulfide and 2.26 g of 70% methane sulfonic acid in Example 8. While stirring, the pressure in the flask was reduced to about 10 Torr and the temperature was increased to approximately 140° C. These conditions were maintained for a time period of about 2.7 hours, at which time a sample of the round-bottomed flask was removed for analysis.

A summary of calculated values from the C-13 spectrum of Examples 4-8 is provided in Table IV. The calculated values in Table IV are no longer relied upon. Applicants believe that the assumptions regarding the expected or theoretical oligomer repeat unit used to generate the calculated values are likely incorrect and led to an inaccurate determination of the calculated values in Table IV.

TABLE III
HPLC Analysis of Oligomerized Product Composition of Example 6.

| Retention Time (min) | Product Type | Area Percentage |
|---|---|---|
| 11.21 | Cyclics | 6.2 |
| 60.54 | Non-Cyclics | 93.8 |

TABLE IV
Calculated Values from C-13 Spectra of Examples 4-8

| | | DiHEDS + DiHETS | End | | Cyclic/ |
|---|---|---|---|---|---|
| | Repeat | +S4 and above | Groups | Mono S | Dimer |
| Example | Units | (mole %) | (mole %) | (mole %) | (mole %) |
| 4 | 3.9 | 49.5 | 33.9 | 16.1 | 0.4 |
| 5 | 7.8 | 60.7 | 14.7 | 24.1 | 0.5 |
| 6 | 4.5 | 51.6 | 28.8 | 19.5 | 0.2 |
| 7 | 4.9 | 53.9 | 25.3 | 20.4 | 0.4 |
| 8 | 4.7 | 53.7 | 27.1 | 18.8 | 0.5 |

Notes on Table IV:
DiHEDS = dihydroxydiethyl disulfide
DiHETS = dihydroxydiethyl trisulfide

### Example 9

### Oligomerization of Dihydroxydiethyl Disulfide Using a Non-Solvent Process

A 5000 mL, 4-necked round-bottomed flask was equipped with a vacuum pump with an intervening dry ice trap, a mechanical stirrer, and a nitrogen purge line. 1563 g of dihydroxydiethyl disulfide were charged to the flask, and the contents were heated to approximately 130° C. while stirring. Then, 1.8 g of 70% methane sulfonic acid were added to the flask, the pressure was reduced to about 10 Torr, and the temperature was increased to approximately 140° C. These conditions were maintained for a time period of about 3 hours. After the vacuum pump was turned off, a nitrogen purge was initiated, and the flask and its contents were cooled, a sample of the 1331 g of product in the flask was retained for analysis.

### Example 10

### Oligomerization of Dihydroxydiethyl Disulfide Using a Non-Solvent Process

A 1000 mL, 3-necked round-bottomed flask was equipped with a vacuum pump with an intervening dry ice trap, a mechanical stirrer, and a nitrogen purge line. 440 g of dihydroxydiethyl disulfide were charged to the flask, the contents were heated to approximately 140° C., and the pressure was reduced to about 10 Torr while stirring. Then, 0.53 g of 70% methane sulfonic acid were added to the flask, the pressure was again reduced to about 10 Torr, and the temperature was controlled in the 135-146° C. range. These conditions were maintained for a time period of about 1 hour. After the vacuum pump was turned off, a nitrogen purge was initiated, and the flask and its contents were cooled, a sample of the 405 g of product in the flask was retained for analysis. Approximately 28 g of water were removed during this experiment.

### Example 11

### Oligomerization of Dihydroxydiethyl Disulfide Using a Non-Solvent Process

A 5000 mL, 4-necked round-bottomed flask was equipped with a vacuum pump with an intervening dry ice trap, a mechanical stirrer, and a nitrogen purge line. 2201 g of dihydroxydiethyl disulfide were charged to the flask, and the contents were heated to approximately 130° C. while stirring. Then, 2.77 g of 70% methane sulfonic acid were added to the flask, the pressure was reduced to about 15 Torr, and the temperature was increased to approximately 140° C. These conditions were maintained for a time period of about 3 hours. After the vacuum pump was turned off, a nitrogen purge was initiated, and the flask and its contents were cooled, a sample of the product in the flask was retained for analysis.

### Example 12

### Oligomerization of Dihydroxydiethyl Disulfide Using a Non-Solvent Process

A 5000 mL, 4-necked round-bottomed flask was equipped with a vacuum pump with an intervening dry ice trap, a mechanical stirrer, and a nitrogen purge line. 2206 g of dihydroxydiethyl disulfide were charged to the flask, the contents were heated to approximately 123° C., and the pressure was reduced to about 10 Torr while stirring. Then, 2.41 g of 70% methane sulfonic acid were added to the flask, the pressure was again reduced to about 10 Torr, and the temperature was increased to approximately 140° C. These conditions were maintained for a time period of about 2 hours. After the vacuum pump was turned off, a nitrogen purge was initiated, and the flask and its contents were cooled, a sample of the product in the flask was retained for analysis.

### Example 13

### Oligomerization of Dihydroxydiethyl Disulfide Using a Non-Solvent Process

A 5000 mL, 4-necked round-bottomed flask was equipped with a vacuum pump with an intervening dry ice trap, a mechanical stirrer, and a nitrogen purge line. 2200 g of dihydroxydiethyl disulfide were charged to the flask, the contents were heated to approximately 135° C., and the pressure was reduced to about 10 Torr while stirring. Then, 2.86 g of 70% methane sulfonic acid were added to the flask, the pressure was again reduced to about 10 Torr, and the temperature was increased to approximately 140° C. These conditions were maintained for a time period of about 2 hours. After the vacuum pump was turned off, a nitrogen purge was initiated, and the flask and its contents were cooled, a sample of the 1863 g of product in the flask was retained for analysis. Approximately 283 g of water were removed during this experiment.

### Example 14

### Oligomerization of Dihydroxydiethyl Disulfide Using a Non-Solvent Process

A 5000 mL, 4-necked round-bottomed flask was equipped with a vacuum pump with an intervening dry ice trap, a mechanical stirrer, and a nitrogen purge line. 2401 g of dihydroxydiethyl disulfide were charged to the flask, the contents were heated to approximately 120° C., and the pressure was reduced to about 10 Torr while stirring. Then, 2.7 g of 70% methane sulfonic acid were added to the flask, the pressure was again reduced to about 10 Torr, and the temperature was increased to approximately 140° C. These conditions were maintained for a time period of about 2.5 hours. After the vacuum pump was turned off, a nitrogen purge was initiated, and the flask and its contents were cooled, a sample of the product in the flask was retained for analysis.

### Example 15

### Oligomerization of Dihydroxydiethyl Disulfide Using a Non-Solvent Process

A 5000 mL, 4-necked round-bottomed flask was equipped with a vacuum pump with an intervening dry ice trap, a mechanical stirrer, and a nitrogen purge line. 2404 g of dihydroxydiethyl disulfide were charged to the flask, the contents were heated to approximately 120° C., and the pressure was reduced to about 10 Torr while stirring. Then, 2.7 g of 70% methane sulfonic acid were added to the flask, the pressure was again reduced to about 10 Torr, and the temperature was increased to approximately 140° C. These conditions were maintained for a time period of about 2 hours. After the vacuum pump was turned off, a nitrogen purge was initiated, and the flask and its contents were cooled, a sample of the product in the flask was retained for analysis.

### Example 16

### Oligomerization of Dihydroxydiethyl Disulfide Using a Non-Solvent Process

A 5000 mL, 4-necked round-bottomed flask was equipped with a vacuum pump with an intervening dry ice trap, a mechanical stirrer, and a nitrogen purge line. 2400 g of dihydroxydiethyl disulfide were charged to the flask, the contents were heated to approximately 120° C., and the pressure was reduced to about 10 Torr while stirring. Then, 2.8-2.9 g of 70% methane sulfonic acid were added to the flask, the pressure was again reduced to about 10 Torr, and the temperature was increased to approximately 140-141° C. These conditions were maintained for a time period of about 2.5 hours. After the vacuum pump was turned off, a nitrogen purge was initiated, and the flask and its contents were cooled, a sample of the product in the flask was retained for analysis.

### Example 17

### Oligomerization of Dihydroxydiethyl Disulfide Using a Non-Solvent Process

A 5000 mL, 4-necked round-bottomed flask was equipped with a vacuum pump with an intervening dry ice trap, a mechanical stirrer, and a nitrogen purge line. 2400 g of dihydroxydiethyl disulfide were charged to the flask, the contents were heated to approximately 121° C., and the pressure was reduced to about 10 Torr while stirring. Then, 2.7 g of 70% methane sulfonic acid were added to the flask, the pressure was again reduced to about 10 Torr, and the temperature was increased to approximately 140° C. These conditions were maintained for a time period of about 2.5 hours. After the vacuum pump was turned off, a nitrogen purge was initiated, and the flask and its contents were cooled, a sample of the product in the flask was retained for analysis.

### Example 18

### Oligomerization of Dihydroxydiethyl Disulfide Using a Non-Solvent Process

A 5000 mL, 4-necked round-bottomed flask was equipped with a vacuum pump with an intervening dry ice trap, a mechanical stirrer, and a nitrogen purge line. 2400 g of dihydroxydiethyl disulfide were charged to the flask, and the contents were heated to approximately 120° C. while stirring. Then, 2.73 g of 70% methane sulfonic acid were added to the flask, the pressure was reduced to about 10 Torr, and the temperature was increased to approximately 139-144° C. These conditions were maintained for a time period of about 2.5 hours. After the vacuum pump was turned off, a nitrogen purge was initiated, and the flask and its contents were cooled, a sample of the 2014 g of product in the flask was retained for analysis. Approximately 244 g of water were removed during this experiment.

### Discussion of Examples 1-18

Table V summarizes molecular weight data (Mₙ=number average molecular weight; M_{w}=weight average molecular weight; and M_{w}/Mₙ=polydispersity, a measure of the molecular weight distribution) for certain compositions (including residual monomer) and oligomers of the compositions (excluding residual monomer) of Examples 1-18. The GPC method discussed above was employed, however, an unstabilized solvent (e.g., no BHT) was used.

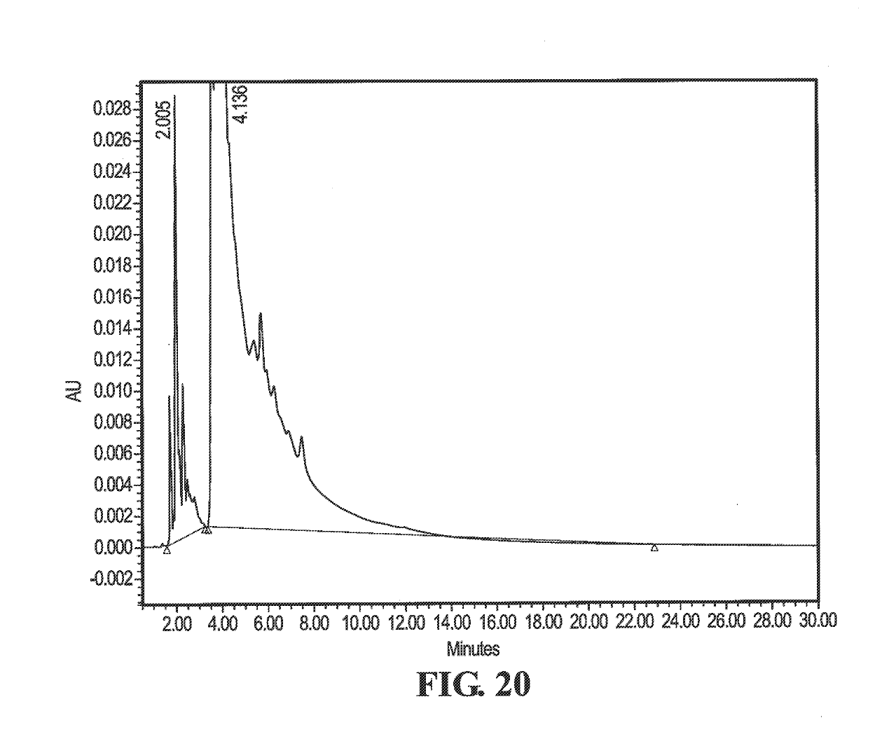

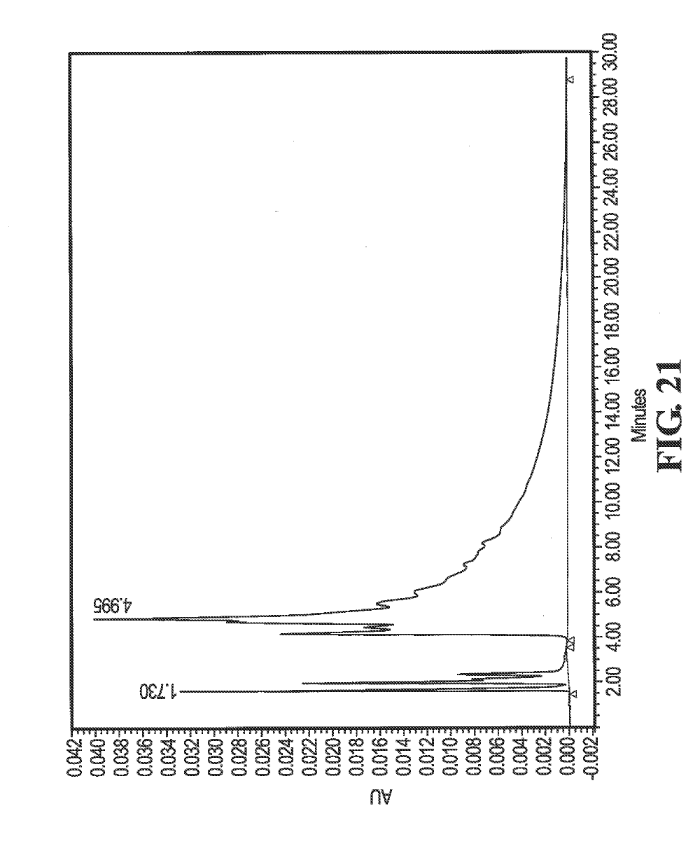

Table V also summarizes the area percentage of cyclic oligomer compounds in certain oligomerized product compositions (including residual monomer) of Examples 1-18. The percentages are area percentages. The HPLC method used an unstabilized solvent (e.g., no BHT), the analytical HPLC procedure, and the analytical HPLC column described above. The analytical HPLC analysis of the oligomerized product composition of Example 2 is illustrated in FIG. 20 (7.76 area percentage of cyclic oligomeric compounds). Similarly, the analytical HPLC analysis of the oligomerized product composition of Example 9 is illustrated in FIG. 21 (8.13 area percentage of cyclic oligomeric compounds).

FIGS. 1-4 demonstrate that the compositions (and oligomers of the compositions) of Examples 4-18 are different from those in Comparative Examples 1-3. Notably, compositions produced in the absence of an organic solvent, as illustrated by Examples 9-11, 15, and 18, have less cyclic oligomer content at a given M_{w}, as compared to compositions produced with an organic solvent at a different temperature and pressure (Examples 1-3). In FIG. 1, for instance, there is a line correlating the percent cyclic oligomer content versus M_{w}, % cyclics=(4.18×10⁻⁵*M_{w})+0.016. On this line, if the M_{w} were 2000 g/mol, the percent cyclic content would be approximately 10% (approximately 0.10). Each of Examples 6-11, 15, and 18 falls below the line, indicating less cyclic content at a respective M_{w}, while each of Examples 1-3 is above the line, indicating greater cyclic content at a respective M_{w}. FIG. 1 considers the M_{w} of the oligomer product composition, inclusive of any residual monomer. FIG. 2 is similar to FIG. 1, but with the addition of a lower dashed line having the formula, % cyclics=(2.32×10⁻⁶*M_{w})+0.0009. Each of Examples 6-11, 15, and 18 is in between the solid line and the dashed line, whereas Examples 1-3 are not.

FIGS. 3-4 are similar to FIGS. 1-2, respectively, except that FIGS. 3-4 consider the M_{w} of oligomers of the compositions, therefore, excluding any residual monomer. In FIG. 3, each of Examples 6-11, 15, and 18 is below the solid line, whereas Examples 1-3 are above the solid line. Similarly, in FIG. 4, each of Examples 6-11, 15, and 18 is between the solid line and the dashed line, whereas Examples 1-3 are not.

### Examples 19-20

### LiAlH₄ Reduction of Bis(Beta-Hydroxy)Polysulfide Oligomers

### Example 19

A 3-necked flask was equipped with an addition funnel, a reflux condenser connected to a bubbler, and a nitrogen purge line. Approximately 5 g of LiAlH₄ and 250 mL of diethyl ether were added to the flask, cooled in an ice water bath, and purged with nitrogen. Then, 17 g of the oligomerized product composition of Example 3 were dissolved in 25 mL of anhydrous THF, and the resulting oligomer solution was transferred to the addition funnel The ice water bath was removed, and the oligomer solution was added dropwise at room temperature while stirring over several hours. After about 24 hours of reaction time, the flask contents were cooled in an ice water bath, and about 70 mL of water were added. Then, 250 mL of 1 N HCl were added to the flask. This mixture was poured into a separation funnel, the ether phase was removed, and the aqueous phase was re-extracted with fresh diethyl ether. The ether portions were combined and dried over MgSO₄. The remaining volatiles (e.g., ether, THF) were removed under vacuum. The resulting LiAlH₄ reduced dihydroxydiethyl disulfide oligomer products of Example 19 were analyzed by the MALDI-TOF procedure described above.

### Example 20

A 3-necked flask was equipped with an addition funnel, a reflux condenser connected to a bubbler, and a nitrogen purge line. Approximately 5 g of LiAlH₄ and 250 mL of diethyl ether were added to the flask, cooled in an ice water bath, and purged with nitrogen. Then, 17 g of the oligomerized product composition of Example 10 were dissolved in 25 mL of anhydrous THF, and the resulting oligomer solution was transferred to the addition funnel The ice water bath was removed, and the oligomer solution was added dropwise at room temperature while stirring over several hours. After about 24 hours of reaction time, the flask contents were cooled in an ice water bath, and about 140 mL of water were added. Then, 200 mL of 0.1 N HCl and 150 mL of 0.2 N HCl were added to the flask. This mixture was poured into a separation funnel, the ether phase was removed, and the aqueous phase was re-extracted with fresh diethyl ether. The ether portions were combined and dried over MgSO₄. The remaining volatiles (e.g., ether, THF) were removed under vacuum. The resulting LiAlH₄ reduced dihydroxydiethyl disulfide oligomer products of Example 20 were analyzed by the MALDI-TOF procedure described above.

### Discussion of Examples 19-20

Table VI and Table VII show the LiAlH₄ reduced dihydroxydiethyl disulfide oligomer dimercaptan products having Structure R3 as a matrix of the number of units of RP3 and RP4 present in Example 19 and Example 20, respectively. Comparing the matrix of Table VI to the matrix of Table VII, it can be observed that the LiAlH₄ reduced dihydroxydiethyl disulfide oligomer dimercaptan products produced in Example 20 have a higher proportion of units having Structure RP4 than the LiAlH₄ reduced dihydroxydiethyl disulfide oligomer dimercaptan products produced in Example 19 (the oligomer produced was based on the procedure of Bertozzi).

Reviewing Table VI, the largest c of a LiAlH₄ reduced dihydroxydiethyl disulfide oligomer dimercaptan product having Structure R4 in Example 19, for the dihydroxydiethyl disulfide oligomer produced in Example 3 (based on the procedure of Bertozzi), was 8, while the largest b of a LiAlH₄ reduced bis(beta-hydroxy)polysulfide oligomer dimercaptan product having Structure R5 in Example 19, for the dihydroxydiethyl disulfide oligomer produced in Example 3 (based on the procedure of Bertozzi), was 6. The ratio of the largest c of a LiAlH₄ reduced dihydroxydiethyl disulfide oligomer dimercaptan product having Structure R4 in Example 19 to the largest b of a LiAlH₄ reduced dihydroxydiethyl disulfide oligomer dimercaptan product having Structure R5 in Example 19, for the dihydroxydiethyl disulfide oligomer produced in Example 3 (the oligomer produced was based on the procedure of Bertozzi), was 8:6 or 1.33:1.

Reviewing Table VII, the largest c of a LiAlH₄ reduced dihydroxydiethyl disulfide oligomer dimercaptan product having Structure R4 in Example 20, for the dihydroxydiethyl disulfide oligomer produced in Example 10, was 4, while the largest b of a LiAlH₄ reduced bis(beta-hydroxy)polysulfide oligomer dimercaptan product having Structure R⁵ in Example 20, for the dihydroxydiethyl disulfide oligomer produced in Example 10, was 13. The ratio of the largest c of a LiAlH₄ reduced dihydroxydiethyl disulfide oligomer dimercaptan product having Structure R⁴ in Example 20 to the largest b of a LiAlH₄ reduced dihydroxydiethyl disulfide oligomer dimercaptan product having Structure R⁵ in Example 20, for the dihydroxydiethyl disulfide oligomer produced in Example 10, was 4:13 or 0.3:1.

TABLE V
Summary of Molecular Weight and Cyclic Data for Examples 1-18.

| | Including | | | | | | | |
|---|---|---|---|---|---|---|---|---|
| | Monomer | | | | | | HPLC | |
| Exam- | | | M_{w}/ | Excluding Monomer | | | | Non |
| ple | Mₙ | M_{W} | Mₙ | Mₙ | M_{W} | M_{w}/Mₙ | Cyclics | Cyclics |
| 1 | 864 | 1631 | 1.89 | 1001 | 1699 | 1.70 | 11.97% | 88.03% |
| 2 | 660 | 1120 | 1.70 | 784 | 1194 | 1.52 | 7.76% | 92.24% |
| 3 | 1218 | 2734 | 2.24 | 1385 | 2787 | 2.01 | 14.59% | 85.41% |
| 4 | | | | | | | | |
| 5 | | | | | | | | |
| 6 | | | | | | | | |
| 7 | | | | | | | | |
| 8 | | | | | | | | |
| 9 | 962 | 2897 | 3.01 | 1175 | 3017 | 2.57 | 8.13% | 91.87% |
| 10 | 540 | 999 | 1.85 | 721 | 1138 | 1.58 | 3.60% | 96.40% |
| 11 | 1536 | 5174 | 3.37 | 1820 | 5285 | 2.90 | 12.97% | 87.03% |
| 12 | | | | | | | 2.61% | 97.39% |
| 13 | 540 | 999 | 1.85 | 721 | 1138 | 1.58 | | |
| 14 | 1020 | 3033 | 2.97 | 1265 | 3165 | 2.50 | | |
| 15 | 517 | 1039 | 2.01 | 698 | 1172 | 1.68 | 3.66% | 96.34% |
| 16 | | | | | | | 3.68% | 96.32% |
| 17 | | | | | | | 6.90% | 93.10% |
| 18 | 756 | 1952 | 2.58 | 976 | 2090 | 2.14 | 4.13% | 95.87% |

TABLE VI
LiAlH₄ reduced dihydroxydiethyl disulfide oligomer dimercaptan product having Structure R3 in Example 19, resulting from the
dihydroxydiethyl disulfide oligomer produced in Example 3.

| Number of | | | | | | | | | | | | | | | |
|---|---|---|---|---|---|---|---|---|---|---|---|---|---|---|---|
| 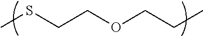 | 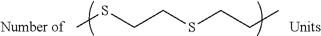 | | | | | | | | | | | | | | |
| Units | 0 | 1 | 2 | 3 | 4 | 5 | 6 | 7 | 8 | 9 | 10 | 11 | 12 | 13 | 14 |
| 0 | | X | X | X | X | X | X | | | | | | | | |
| 1 | X | X | X | X | X | X | | | | | | | | | |
| 2 | X | X | X | X | X | X | | | | | | | | | |
| 3 | X | X | X | X | X | X | | | | | | | | | |
| 4 | X | X | X | X | X | | | | | | | | | | |
| 5 | X | X | X | X | X | | | | | | | | | | |
| 6 | | X | X | X | | | | | | | | | | | |
| 7 | X | X | | | | | | | | | | | | | |
| 8 | X | | | | | | | | | | | | | | |
| 9 | | | | | | | | | | | | | | | |

TABLE VII
LiAlH₄ reduced dihydroxydiethyl disulfide oligomer dimercaptan product having Structure R3 in Example 20, resulting from the
dihydroxydiethyl disulfide oligomer produced in Example 10.

| Number of | | | | | | | | | | | | | | | |
|---|---|---|---|---|---|---|---|---|---|---|---|---|---|---|---|
| 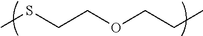 | 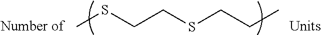 | | | | | | | | | | | | | | |
| Units | 0 | 1 | 2 | 3 | 4 | 5 | 6 | 7 | 8 | 9 | 10 | 11 | 12 | 13 | 14 |
| 0 | | X | X | X | X | X | X | X | X | X | X | X | X | X | |
| 1 | X | X | X | X | X | X | X | X | X | X | X | X | | | |
| 2 | X | X | X | X | X | X | X | X | X | X | | | | | |
| 3 | X | X | X | X | X | X | X | X | X | X | | | | | |
| 4 | X | X | X | | | | | | | | | | | | |
| 5 | | | | | | | | | | | | | | | |
| 6 | | | | | | | | | | | | | | | |
| 7 | | | | | | | | | | | | | | | |
| 8 | | | | | | | | | | | | | | | |
| 9 | | | | | | | | | | | | | | | |

We claim:

1. A process comprising:
(a) contacting an acid catalyst and a composition comprising a bis(beta-hydroxy) polysulfide; and
(b) oligomerizing the bis(beta-hydroxy)polysulfide in the substantial absence of an organic solvent to form oligomers comprising units derived from the bis(beta-hydroxy)polysulfide.

2. The process of claim 1, wherein the acid catalyst and a composition consisting essentially of a bis(beta-hydroxy)polysulfide are contacted in step (a).

3. The process of claim 1, wherein the bis(beta-hydroxy)polysulfide has the formula HOCR¹R²CR³R⁴SₓCR⁸R⁷CR⁶R⁵OH, wherein:
R¹, R², R³, R⁴, R⁵, R⁶, R⁷, and R⁸ are independently H or a C₁ to C₂₀ hydrocarbyl group;
and x has an average value of from 2 to 6.

4. The process of claim 1, wherein the bis(beta-hydroxy)polysulfide comprises dihydroxydiethyl disulfide.

5. The process of claim 1, wherein the acid catalyst has a pKa of less than or equal to 4.

6. The process of claim 1, wherein the acid catalyst comprises benzenesulfonic acid, p-toluene sulfonic acid, methane sulfonic acid, or a combination thereof.

7. The process of claim 1, wherein the acid catalyst is:
present in a range from 0.05 to 6 weight % of the bis(beta-hydroxy)polysulfide;
present in a range from 0.05 to 6 mole % of the bis(beta-hydroxy)polysulfide; or
both.

8. The process of claim 1, wherein the oligomerizing step is:
conducted at a pressure of less than or equal to 100 Torr;
conducted at a temperature in a range from 100° C. to 180° C.; or
both.

9. The process of claim 1, wherein water is formed in the step of oligomerizing the bis(beta-hydroxy)polysulfide, and the formed water is removed during the oligomerizing step.

10. A composition comprising oligomers produced by the process of claim 1.

11. A composition comprising oligomers of a bis(beta-hydroxy)polysulfide, the composition having:
(i) a weight-average molecular weight (M_{w}) in a range from 250 to 15,000 g/mol; and
(ii) an area percentage of cyclic oligomer compounds, % cyclics, characterized by at least one of the following equations:
% cyclics≦(4.18×10⁻⁵*M_{w})+0.0162; and/or
0.25*{(2.32×10⁻⁵*M_{w})+0.009]}≦% cyclics≦1.75*{(2.32×10⁻⁵*M_{w})+0.009]}.

12. The composition of claim 11, wherein the area percentage of the cyclic oligomer compounds, % cyclics, is further characterized by the following equation:
% cyclics≧(2.32×10⁻⁶*M_{w})+0.0009.

13. The composition of claim 11, wherein the composition has a M_{w} in a range from 350 to 6000 g/mol.

14. The composition of claim 11, wherein the bis(beta-hydroxy)polysulfide comprises dihydroxydiethyl disulfide.

15. The composition of claim 14, wherein a ratio of the largest c of a LiAlH₄ reduced bis(beta-hydroxy)polysulfide oligomer dimercaptan product having the structure 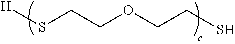
to the largest b of a LiAlH₄ reduced bis(beta-hydroxy)polysulfide oligomer dimercaptan product having the structure 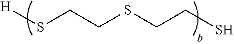
is less than or equal to 1.1.

16. A composition comprising oligomers of a bis(beta-hydroxy)polysulfide, the composition having:
(i) a weight-average molecular weight (M_{w}) of the oligomers in a range from 250 to 15,000 g/mol; and
(ii) an area percentage of cyclic oligomer compounds, % cyclics, characterized by at least one of the following equations:
% cyclics≦(4.19×10⁻⁵*M_{w})+0.0104; and/or
0.25*{(2.33×10⁻⁵*M_{w})+0.0058]}≦% cyclics≦1.75*{(2.33×10⁻⁵*M_{w})+0.0058]}.

17. The composition of claim 16, wherein the area percentage of the cyclic oligomer compounds, % cyclics, is further characterized by following equation:
% cyclics≧(2.33×10⁻⁶*M_{w})+0.00058.

18. The composition of claim 16, wherein the M_{w} of the oligomers is in a range from 350 to 6000 g/mol.

19. The composition of claim 16, wherein the bis(beta-hydroxy)polysulfide comprises dihydroxydiethyl disulfide.

20. The composition of claim 19, wherein a ratio of the largest c of a LiAlH₄ reduced bis(beta-hydroxy)polysulfide oligomer dimercaptan product having the structure 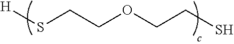
to the largest b of a LiAlH₄ reduced bis(beta-hydroxy)polysulfide oligomer dimercaptan product having the structure 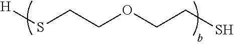
is less than or equal to 1.1.
